(19) United States
(12) Patent Application Publication
(10) Pub. No.: US 2016/0282541 A1
(43) Pub. Date: Sep. 29, 2016

(54) OPTICAL FILM STACK FOR DISPLAY DEVICES

(71) Applicant: Pixtronix, Inc., San Diego, CA (US)

(72) Inventors: Jianru Shi, Haverhill, MA (US); Yuhong Yao, Wakefield, MA (US); Lu Lu, Medford, MA (US); Jignesh Gandhi, Burlington, MA (US); Xiang-Dong Mi, Acton, MA (US); James Eakin, Worcester, MA (US); Robert Myers, Lowell, MA (US); Waseem Mohammad, Andover, MA (US); Matthew Brian Sampsell, San Jose, CA (US)

(21) Appl. No.: 14/668,893

(22) Filed: Mar. 25, 2015

(51) Int. Cl. F21V 8/00; G02B 26/02

(52) U.S. Cl. CPC G02B 6/0053; G02B 6/0036; G02B 26/02; G02B 6/0055

(57) ABSTRACT

This disclosure provides systems, methods and apparatus for providing stacks of optical films that may be used to provide increased on-axis display brightness. In one aspect, an apparatus or system may be provided that includes a light source, a first optical film having triangular cross-section, prismatic light-turning structures, and a second optical film having trapezoidal cross-section, prismatic light-turning structures. The first optical film may be interposed between the light source and the second optical film. In further aspects, a third optical film, similar to the first optical film, may be interposed between the light source and the first optical film. In yet further aspects, one or more additional optical films, similar to the second optical film, may be positioned in the stack such that the second optical film is between the first optical film and the additional optical film(s).

### TECHNICAL FIELD

This disclosure relates to brightness-enhancing films for use in display panels and other display systems. More specifically, this disclosure relates to particular optical stacks of optical films for enhancing display brightness.

### DESCRIPTION OF THE RELATED TECHNOLOGY

Electromechanical systems (EMS) include devices having electrical and mechanical elements, actuators, transducers, sensors, optical components such as mirrors and optical films, and electronics. EMS devices or elements can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

Electromechanical systems, such as MEMS and NEMS devices, are increasingly being used in pixelated display devices to control pixel state. Some such electromechanical systems utilize micro- or nano-scale movable shutters that may be moved so as to occlude or not occlude an aperture through which light from a light source may shine. Such displays typically have an aperture plate or layer that has a multitude of openings or apertures that pass through the aperture plate or layer; each pixel may include one or more of these apertures or openings. A light source may be positioned such that light from the light source passes through those apertures that are not blocked by a shutter.

### SUMMARY

The systems, methods and devices of this disclosure each have several innovative aspects, no single one of which is solely responsible for the desirable attributes disclosed herein.

One innovative aspect of the subject matter described in this disclosure can be implemented as an apparatus that includes a first optical film having a first surface and a second surface located opposite the first surface of the first optical film, as well as a second optical film having a first surface facing the first optical film and a second surface located opposite the first surface of the second optical film. The second surface of the first optical film may be defined by a plurality of prismatic light-turning structures. Each prismatic light-turning structure that is included in the plurality of prismatic light-turning structures that defines the second surface of the first optical film may have a substantially triangular cross-section. The second optical film also may include a plurality of prismatic light-turning structures. Each prismatic light-turning structure of the plurality of prismatic light-turning structures included in the second optical film may have a trapezoidal cross-section, and each such trapezoidal cross-section may widen with increasing distance from the first optical film. The first optical film and the second optical film may be positioned in a stacked arrangement with the second surface of the first optical film facing towards the first surface of the second optical film.

In some further implementations, the apparatus also may include a light source and the first optical film may be interposed between the light source and the second optical film.

In some other or additional implementations, the apparatus may further include a display pixel layer having a plurality of display elements, and the second optical film may be interposed between the first optical film and the display pixel layer. In some such implementations, the display pixel layer may include an aperture plate having a plurality of apertures and each display element may include a shutter. Each shutter may be associated with one or more of the apertures and may be configured to be transitioned between a first position in which the shutter occludes the one or more of the associated apertures and a second position in which the shutter permits light to pass through the one or more associated apertures. In some alternative such implementations, the display pixel layer may be a liquid crystal display (LCD) layer.

In some implementations of the apparatus, the prismatic light-turning structures in the plurality of prismatic light-turning structures that defines the second surface of the first optical film have a continuous sawtooth profile when viewed along a direction parallel to the prismatic light-turning structures of the first optical film. In some such implementations of the apparatus, the sawtooth profile is defined by alternating peaks and valleys, each of which forms an angle between 88 and 92 degrees. In some implementations of the apparatus, the first surface of the first optical film may be flat.

In some implementations, the apparatus may further include a third optical film having a first surface and a second surface located on a side of the third optical film opposite the first surface of the third optical film. In such implementations, the second surface of the third optical film may be defined by a plurality of prismatic light-turning structures. Each prismatic light-turning structure that is included in the plurality of prismatic light-turning structures that defines the second surface of the third optical film may have a substantially triangular cross-section, and the third optical film may be positioned in the stacked arrangement with the second surface of the third optical film facing towards the first surface of the first optical film. The third optical film also may be oriented such that the prismatic light-turning structures in the plurality of prismatic light-turning structures that defines the second surface of the third optical film are oriented along a first direction substantially perpendicular to a second direction along which the prismatic light-turning structures in the plurality of prismatic light-turning structures that defines the second surface of the first optical film are oriented.

In some such implementations of the apparatus, the prismatic light-turning structures in the plurality of prismatic light-turning structures that defines the second surface of the first optical film may have a continuous sawtooth profile when viewed along a direction parallel to the prismatic light-turning structures of the first optical film. The prismatic light-turning structures in the plurality of prismatic light-turning structures that defines the second surface of the third optical film may have a continuous sawtooth profile when viewed along a direction parallel to the prismatic light-turning structures of the second optical film.

In some implementations, the apparatus may further include one or more additional optical films, and the second optical film may be interposed between the first optical film and the one or more additional optical films. Each additional optical film may include a plurality of prismatic light-turning structures, and each prismatic light-turning structure of the plurality of prismatic light-turning structures included in each of the one or more additional optical films may have a trapezoidal cross-section.

In some implementations of the apparatus, each prismatic light-turning structure of the plurality of prismatic light-turning structures included in the second optical film may include a first sloped wall portion, a second sloped wall portion, and a base portion that is substantially in-plane with the second optical film and that spans between the first sloped wall portion and the second sloped wall portion. In some such implementations of the apparatus, the second optical film may include interstitial portions that are located between each pair of adjacent base portions and that are substantially in-plane with the first surface of the second optical film. Each such interstitial portion may include reflective material facing towards the first optical film. In some further or alternative such implementations of the apparatus, the first sloped wall portion and the second sloped wall portion of each prismatic light-turning structure of the plurality of prismatic light-turning structures included in the second optical film may form an angle between them greater than or equal to 5° and less than or equal to 45°. In some further or alternative such implementations of the apparatus, the first sloped wall portion and the second sloped wall portion of each prismatic light-turning structure of the plurality of prismatic light-turning structures included in the second optical film may form an angle between them greater than or equal to 5° and less than or equal to 15°. In some further or alternative such implementations of the apparatus, the first sloped wall portion and the second sloped wall portion of each prismatic light-turning structure of the plurality of prismatic light-turning structures included in the second optical film may form an angle between them of approximately 10°. In some further or alternative such implementations of the apparatus, the second optical film may include interstitial portions that are located between each pair of adjacent base portions; the interstitial portions and the base portions may be substantially equal in width.

In some further or alternative such implementations of the apparatus, for each pair of adjacent prismatic light-turning structures in the plurality of trapezoidal light-turning structures included in the second optical film, the first sloped wall portion of one of the prismatic light-turning structures in the pair of adjacent prismatic light-turning structures in the plurality of prismatic light-turning structures included in the second optical film and the second sloped wall portion of the other of the prismatic light-turning structures in the pair of adjacent light-turning structures in the plurality of prismatic light-turning structures included in the second optical film may be provided by opposing walls of a V-shaped groove in the first surface of the second optical film. In some such implementations, the V-shaped grooves may be coated or filled with a material such as a reflective material or a material having a lower index of refraction as compared with the material adjoining the V-shaped grooves.

In some implementations of the apparatus, for each pair of adjacent prismatic light-turning structures in the plurality of prismatic light-turning structures included in the second optical film, the first sloped wall portion of one of the prismatic light-turning structures in the pair of adjacent prismatic light-turning structures in the plurality of prismatic light-turning structures included in the second optical film and the second sloped wall portion of the other of the prismatic light-turning structures in the pair of adjacent prismatic light-turning structures in the plurality of prismatic light-turning structures included in the second optical film may be provided by opposing sides of a protrusion that defines a portion of the second surface of the second optical film. In some such implementations of the apparatus, the first sloped wall portions and the second sloped wall portions may both be coated with a reflective coating.

In some implementations of the apparatus having a display pixel layer, the apparatus may further include a processor capable of communicating with the display elements in the display pixel layer and of processing image data, as well as a memory device capable of communicating with the processor. In some such implementations, the apparatus may further include a driver circuit capable of sending at least one signal to the display elements, as well as a controller capable of sending at least a portion of the image data to the driver circuit. In some additional or alternative such implementations, the apparatus also may include an image source module capable of sending the image data to the processor; the image source module may include at least one receiver, transceiver, or transmitter. In some other additional or alternative such implementations, the apparatus also may include an input device capable of receiving input data and communicating the input data to the processor.

Another innovative aspect of the subject matter described in this disclosure can be implemented as an apparatus that includes a light-emission means for emitting distributed illumination across an illumination surface of the light-emission means, a first optical film, and a second optical film. The first optical film may include first means for reflecting the light from the light-emission means that is substantially aligned with an axis that is normal to the illumination surface of the light-emission means back towards the light-emission means while permitting the light that is not substantially aligned with the axis to pass through the first optical film. The second optical film may include second means for generally permitting the light from the light-emission means that passes through the first optical film and that is substantially aligned with the axis to pass through the second optical film without reflection back towards the light-emission means while causing the light from the light-emission means that passes through the first optical film and that is not substantially aligned with the axis to be reflected so as to be more aligned with the axis.

In some such implementations, the first means may include optical cavities for redirecting the light and may cause the light that is within less than 5 degrees of the axis and that is within these optical cavities to be reflected back towards the light-emission means and also may cause the light that is within 5 degrees to 90 degrees of the axis and within these optical cavities to pass through the first optical film. In some further or alternative such implementations, the second means may include optical cavities for redirecting the light and may cause the light that is within less than 22.5 degrees of the axis and that is within these optical cavities to pass through the second means without being reflected back towards the light-emission means and may cause the light that is within 22.5 to 90 degrees of the axis and that is within these optical cavities to be reflected so as to be more aligned with the axis.

Another innovative aspect of the subject matter described in this disclosure can be implemented as an apparatus that includes a light-emission means for emitting distributed illumination across an illumination surface of the light-emission means, a first optical film, and a second optical film. The first optical film may include first means for reflecting the majority of light from the light-emission means that is substantially aligned with an axis that is normal to the illumination surface of the light-emission means back towards the light-emission means while permitting the majority of light that is not substantially aligned with the axis to pass through the first optical film. The second optical film may include second means for generally permitting the majority of light from the light-emission means that passes through the first optical film and that is substantially aligned with the axis to pass through the second optical film without reflection back towards the light-emission means while causing the majority of light from the light-emission means that passes through the first optical film and that is not substantially aligned with the axis to be reflected so as to be more aligned with the axis.

In some such implementations, the first means may include optical cavities for redirecting the light and may cause the majority of light that is within less than 5 degrees of the axis and that is within these optical cavities to be reflected back towards the light-emission means and also may cause the majority of light that is within 5 degrees to 90 degrees of the axis and within these optical cavities to pass through the first optical film. In some further or alternative such implementations, the second means may include optical cavities for redirecting the light and may cause the majority of light that is within less than 22.5 degrees of the axis and that is within these optical cavities to pass through the second means without being reflected back towards the light-emission means and may cause the majority of light that is within 22.5 to 90 degrees of the axis and that is within these optical cavities to be reflected so as to be more aligned with the axis.

Another innovative aspect of the subject matter described in this disclosure can be implemented as a system that includes a backlight unit (BLU) having a light source, an optical stack including at least one first optical film and one second optical film, and a display pixel layer having a plurality of microelectromechanical systems (MEMS)-based display elements, each MEMS-based display element movable between at least two positions. The first optical film may be interposed between the second optical film and the BLU, and the first optical film may have a plurality of prismatic light-turning structures having a substantially triangular cross-section. The second optical film may have a plurality of prismatic light-turning structures having a trapezoidal cross-section.

In some implementations of the system, the MEMS-based display elements may be digital microshutter elements that are configured to be moved along axes that are parallel to the first optical film and the second optical film. In some other or additional such implementations, the first optical film may have sawtooth profile and the prismatic light-turning structures of the first optical film may have apex angles of 90°. In some additional or alternative such implementations, each prismatic light-turning structure of the second optical film may have sloped wall portions that have an included angle between them of between 5° and 45°.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1A shows a schematic diagram of an example direct-view microelectromechanical systems (MEMS)-based display apparatus.

FIG. 1B shows a block diagram of an example host device.

FIGS. 2A and 2B show views of an example dual actuator shutter assembly.

FIG. 3 depicts a side cross-sectional view of an optical stack arrangement for an example display.

FIG. 4 depicts a side cross-sectional view of an optical stack arrangement for another example display.

FIG. 5 depicts a side cross-sectional view of an example display.

FIG. 6 depicts a side cross-sectional view of another example display.

FIG. 7 depicts an off-angle, three-dimensional cutaway view of an example display.

FIG. 8 depicts a three-dimensional exploded view of the example display of FIG. 7.

FIG. 9 depicts a side section view of one example of a second optical film that uses V-shaped grooves to provide light-turning structures.

FIG. 10 depicts a side section view of one example of another second optical film that uses V-shaped grooves to provide light-turning structures.

FIG. 11 depicts a side section view of one example of a second optical film that uses protrusions to provide light-turning structures.

FIG. 12 depicts a side section view of another example of a second optical film that uses protrusions to provide light-turning structures.

FIG. 13 depicts a side section view of an example first optical film.

FIG. 14 depicts a side section view of another example first optical film.

FIG. 15 depicts a side section view of yet another example first optical film.

FIG. 16 depicts a side section view of yet another example first optical film.

FIG. 17 depicts a side section view of another example of a first optical film.

FIG. 18 depicts a diagram showing hypothetical brightness data for various example optical stack configurations.

FIG. 19 is a plot of simulation data showing brightness as a function of viewing angle for example optical stacks with and without an optical layer having trapezoidal light-turning structures.

FIGS. 20A and 20B show system block diagrams of an example display device that includes a plurality of display elements.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. The described implementations may be implemented in any device, apparatus, or system that is capable of displaying an image, whether in motion (such as video) or stationary (such as still images), and whether textual, graphical or pictorial. The concepts and examples provided in this disclosure may be applicable to a variety of displays, such as liquid crystal displays (LCDs), organic light-emitting diode (OLED) displays, field emission displays, and electromechanical systems (EMS) and microelectromechanical (MEMS)-based displays, in addition to displays incorporating features from one or more display technologies.

The described implementations may be included in or associated with a variety of electronic devices such as, but not limited to: mobile telephones, multimedia Internet enabled cellular telephones, mobile television receivers, wireless devices, smartphones, Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, wearable devices, clocks, calculators, television monitors, flat panel displays, electronic reading devices (such as e-readers), computer monitors, auto displays (such as odometer and speedometer displays), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) and nanoelectromechanical systems (NEMS) applications, in addition to non-EMS applications), aesthetic structures (such as display of images on a piece of jewelry or clothing) and a variety of EMS devices.

The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

Disclosed herein are structures and techniques for enhancing on-axis brightness in various types of display devices, most notably in display devices utilizing MEMS- or NEMS-type electromechanical shutter mechanisms, which may be referred to herein as “digital microshutters” (DMS) or the like. Generally speaking, DMS-type displays include a light source, such as a backlight unit (BLU), one or more aperture plates that include a number of apertures through which light from the light source may travel, and a plurality of shutters, each of which may be controllably moved in front of, or away from, one or more apertures so as to selectively prevent light from passing through the aperture plate. The BLU typically includes several components, such as a light source, a light guide, and a brightness-enhancing film or a stack of two brightness-enhancing films arranged orthogonally to one another. For example, some example BLUs may utilize a stack of two layers of Vikuiti™ brightness enhancement films (BEF) II (as offered by the 3M company).

The conventional approach to implementing BEFs is to include one or two, but not more, optical films such as the Vikuiti BEF II films; such optical films may generally be described as having a “sawtooth” profile, i.e., the surface of the optical film facing the light source may generally be flat, and the surface facing away from the light source may be formed by a plurality of triangular cross-section prismatic light-turning structures distributed continuously across the optical film.

Presented herein are improved optical stacks that include one, or two orthogonally-crossed, sawtooth-profile optical films, such as the Vikuiti BEF II films, in combination with one or more additional optical films having trapezoidal cross-section, prismatic light-turning structures and located such that the sawtooth-profile optical films are interposed between the light source and the one or more additional optical films may provide improved performance in a display as compared with optical stacks constructed according to the conventional approach.

Particular implementations of the subject matter described in this disclosure can be implemented to realize one or more of the following potential advantages. Optical stacks incorporating one or two sawtooth-profile optical films interposed between a light source and one or more optical films having trapezoidal cross-section, prismatic light-turning structures as discussed herein may be advantageous since they provide superior on-axis brightness as compared with optical stacks featuring one or two sawtooth-profile optical films without subsequent trapezoidal optical films. Moreover, such optical stacks also may provide superior on-axis brightness as compared with optical stacks featuring optical film(s) having trapezoidal light-turning structures without preceding sawtooth-profile optical films. In other words, there is a synergistic effect provided by the combination of one or two sawtooth profile optical films and one or more optical films having trapezoidal light-turning structures in the manner described herein.

Optical stacks with such superior on-axis brightness may be particularly advantageous when used in display devices utilizing DMS technology. This is because the thickness of the display pixel layer, i.e., the aperture plate(s), shutter mechanisms, and attendant control and structural layers, in concert with the dimensions of the apertures used, may cause a large amount of light that enters the aperture at high off-normal angles to strike a surface of the shutter or the aperture(s) as it traverses through the display pixel layer, for example, light that enters the shutter aperture at a high off-normal angle may strike the sidewalls of the aperture or the aperture plate and thus be “clipped” and thereby prevented from exiting the shutter aperture. This, in turn, causes the light to be reflected and possibly lost, resulting in lower display brightness. By using an optical stack with superior on-axis brightness, such as those described herein, a greater amount of light may be directed on-axis, resulting in a reduced chance that such light will strike a surface of the shutter or the aperture as it passes through the display pixel layer.

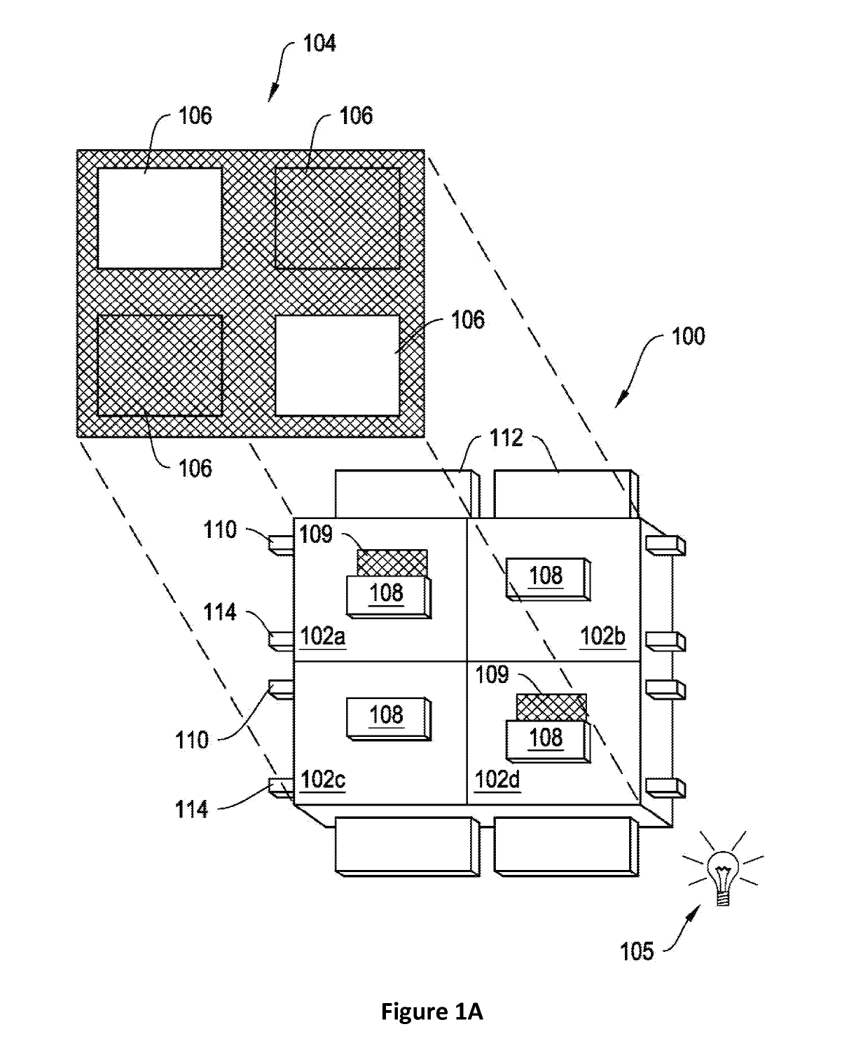

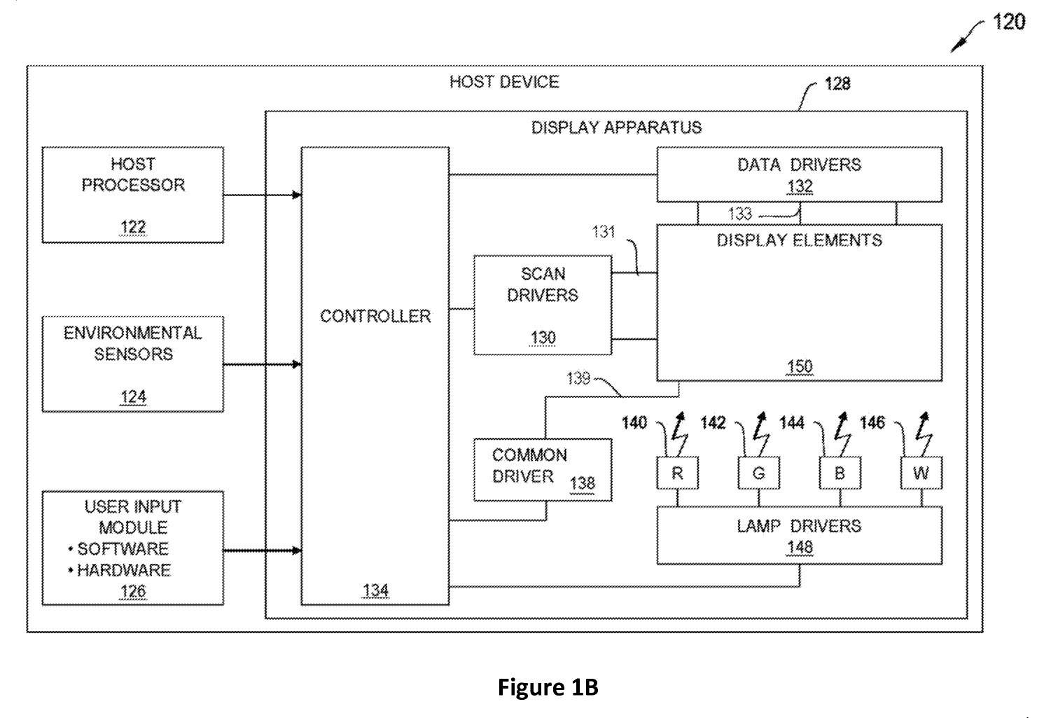

FIG. 1A shows a schematic diagram of an example direct-view MEMS-based display apparatus 100. The display apparatus 100 includes a plurality of light modulators 102a-102d (generally light modulators 102) arranged in rows and columns. In the display apparatus 100, the light modulators 102a and 102d are in the open state, allowing light to pass. The light modulators 102b and 102c are in the closed state, obstructing the passage of light. By selectively setting the states of the light modulators 102a-102d, the display apparatus 100 can be utilized to form an image 104 for a backlit display, if illuminated by a lamp or lamps 105. In another implementation, the apparatus 100 may form an image by reflection of ambient light originating from the front of the apparatus. In another implementation, the apparatus 100 may form an image by reflection of light from a lamp or lamps positioned in the front of the display, i.e., by use of a front light.

In some implementations, each light modulator 102 corresponds to a pixel 106 in the image 104. In some other implementations, the display apparatus 100 may utilize a plurality of light modulators to form a pixel 106 in the image 104. For example, the display apparatus 100 may include three color-specific light modulators 102. By selectively opening one or more of the color-specific light modulators 102 corresponding to a particular pixel 106, the display apparatus 100 can generate a color pixel 106 in the image 104. In another example, the display apparatus 100 includes two or more light modulators 102 per pixel 106 to provide a luminance level in an image 104. With respect to an image, a pixel corresponds to the smallest picture element defined by the resolution of image. With respect to structural components of the display apparatus 100, the term pixel refers to the combined mechanical and electrical components utilized to modulate the light that forms a single pixel of the image.

The display apparatus 100 is a direct-view display in that it may not include imaging optics typically found in projection applications. In a projection display, the image formed on the surface of the display apparatus is projected onto a screen or onto a wall. The display apparatus is substantially smaller than the projected image. In a direct view display, the image can be seen by looking directly at the display apparatus, which contains the light modulators and optionally a backlight or front light for enhancing brightness and/or contrast seen on the display.

Direct-view displays may operate in either a transmissive or reflective mode. In a transmissive display, the light modulators filter or selectively block light which originates from a lamp or lamps positioned behind the display. The light from the lamps is optionally injected into a light guide or backlight so that each pixel can be uniformly illuminated. Transmissive direct-view displays are often built onto transparent substrates to facilitate a sandwich assembly arrangement where one substrate, containing the light modulators, is positioned over the backlight. In some implementations, the transparent substrate can be a glass substrate (sometimes referred to as a glass plate or panel), or a plastic substrate. The glass substrate may be or include, for example, a borosilicate glass, wine glass, fused silica, a soda lime glass, quartz, artificial quartz, Pyrex, or other suitable glass material.

Each light modulator 102 can include a shutter 108 and an aperture 109. To illuminate a pixel 106 in the image 104, the shutter 108 is positioned such that it allows light to pass through the aperture 109. To keep a pixel 106 unlit, the shutter 108 is positioned such that it obstructs the passage of light through the aperture 109. The aperture 109 is defined by an opening patterned through a reflective or light-absorbing material in each light modulator 102.

The display apparatus also includes a control matrix coupled to the substrate and to the light modulators for controlling the movement of the shutters. The control matrix includes a series of electrical interconnects (such as interconnects 110, 112 and 114), including at least one write-enable interconnect 110 (also referred to as a scan line interconnect) per row of pixels, one data interconnect 112 for each column of pixels, and one common interconnect 114 providing a common voltage to all pixels, or at least to pixels from both multiple columns and multiples rows in the display apparatus 100. In response to the application of an appropriate voltage (the write-enabling voltage, VWE), the write-enable interconnect 110 for a given row of pixels prepares the pixels in the row to accept new shutter movement instructions. The data interconnects 112 communicate the new movement instructions in the form of data voltage pulses. The data voltage pulses applied to the data interconnects 112, in some implementations, directly contribute to an electrostatic movement of the shutters. In some other implementations, the data voltage pulses control switches, such as transistors or other non-linear circuit elements that control the application of separate drive voltages, which are typically higher in magnitude than the data voltages, to the light modulators 102. The application of these drive voltages results in the electrostatic driven movement of the shutters 108.

The control matrix also may include, without limitation, circuitry, such as a transistor and a capacitor associated with each shutter assembly. In some implementations, the gate of each transistor can be electrically connected to a scan line interconnect. In some implementations, the source of each transistor can be electrically connected to a corresponding data interconnect. In some implementations, the drain of each transistor may be electrically connected in parallel to an electrode of a corresponding capacitor and to an electrode of a corresponding actuator. In some implementations, the other electrode of the capacitor and the actuator associated with each shutter assembly may be connected to a common or ground potential. In some other implementations, the transistor can be replaced with a semiconducting diode, or a metal-insulator-metal switching element.

FIG. 1B shows a block diagram of an example host device 120 (i.e., cell phone, smart phone, PDA, MP3 player, tablet, e-reader, netbook, notebook, watch, wearable device, laptop, television, or other electronic device). The host device 120 includes a display apparatus 128 (such as the display apparatus 100 shown in FIG. 1A), a host processor 122, environmental sensors 124, a user input module 126, and a power source.

The display apparatus 128 includes a plurality of scan drivers 130 (also referred to as write enabling voltage sources), a plurality of data drivers 132 (also referred to as data voltage sources), a controller 134, common drivers 138, lamps 140-146, lamp drivers 148 and an array of display elements 150, such as the light modulators 102 shown in FIG. 1A. The scan drivers 130 apply write enabling voltages to scan line interconnects 131. The data drivers 132 apply data voltages to the data interconnects 133.

In some implementations of the display apparatus, the data drivers 132 are capable of providing analog data voltages to the array of display elements 150, especially where the luminance level of the image is to be derived in analog fashion. In analog operation, the display elements are designed such that when a range of intermediate voltages is applied through the data interconnects 133, there results a range of intermediate illumination states or luminance levels in the resulting image. In some other implementations, the data drivers 132 are capable of applying a reduced set, such as 2, 3 or 4, of digital voltage levels to the data interconnects 133. In implementations in which the display elements are shutter-based light modulators, such as the light modulators 102 shown in FIG. 1A, these voltage levels are designed to set, in digital fashion, an open state, a closed state, or other discrete state to each of the shutters 108. In some implementations, the drivers are capable of switching between analog and digital modes.

The scan drivers 130 and the data drivers 132 are connected to a digital controller circuit 134 (also referred to as the controller 134). The controller 134 sends data to the data drivers 132 in a mostly serial fashion, organized in sequences, which in some implementations may be predetermined, grouped by rows and by image frames. The data drivers 132 can include series-to-parallel data converters, level-shifting, and for some applications digital-to-analog voltage converters.

The display apparatus optionally includes a set of common drivers 138, also referred to as common voltage sources. In some implementations, the common drivers 138 provide a DC common potential to all display elements within the array of display elements 150, for instance by supplying voltage to a series of common interconnects 139. In some other implementations, the common drivers 138, following commands from the controller 134, issue voltage pulses or signals to the array of display elements 150, for instance global actuation pulses which are capable of driving and/or initiating simultaneous actuation of all display elements in multiple rows and columns of the array.

Each of the drivers (such as scan drivers 130, data drivers 132 and common drivers 138) for different display functions can be time-synchronized by the controller 134. Timing commands from the controller 134 coordinate the illumination of red, green, blue and white lamps (140, 142, 144 and 146 respectively) via lamp drivers 148, the write-enabling and sequencing of specific rows within the array of display elements 150, the output of voltages from the data drivers 132, and the output of voltages that provide for display element actuation. In some implementations, the lamps are light emitting diodes (LEDs).

The controller 134 determines the sequencing or addressing scheme by which each of the display elements can be re-set to the illumination levels appropriate to a new image 104. New images 104 can be set at periodic intervals. For instance, for video displays, color images or frames of video are refreshed at frequencies ranging from 10 to 300 Hertz (Hz). In some implementations, the setting of an image frame to the array of display elements 150 is synchronized with the illumination of the lamps 140, 142, 144 and 146 such that alternate image frames are illuminated with an alternating series of colors, such as red, green, blue and white. The image frames for each respective color are referred to as color subframes. In this method, referred to as the field sequential color method, if the color subframes are alternated at frequencies in excess of 20 Hz, the human visual system (HVS) will average the alternating frame images into the perception of an image having a broad and continuous range of colors. In some other implementations, the lamps can employ primary colors other than red, green, blue and white. In some implementations, fewer than four, or more than four lamps with primary colors can be employed in the display apparatus 128.

In some implementations, where the display apparatus 128 is designed for the digital switching of shutters, such as the shutters 108 shown in FIG. 1A, between open and closed states, the controller 134 forms an image by the method of time division gray scale. In some other implementations, the display apparatus 128 can provide gray scale through the use of multiple display elements per pixel.

In some implementations, the data for an image state is loaded by the controller 134 to the array of display elements 150 by a sequential addressing of individual rows, also referred to as scan lines. For each row or scan line in the sequence, the scan driver 130 applies a write-enable voltage to the write enable interconnect 131 for that row of the array of display elements 150, and subsequently the data driver 132 supplies data voltages, corresponding to desired shutter states, for each column in the selected row of the array. This addressing process can repeat until data has been loaded for all rows in the array of display elements 150. In some implementations, the sequence of selected rows for data loading is linear, proceeding from top to bottom in the array of display elements 150. In some other implementations, the sequence of selected rows is pseudo-randomized, in order to mitigate potential visual artifacts. And in some other implementations, the sequencing is organized by blocks, where, for a block, the data for a certain fraction of the image is loaded to the array of display elements 150. For example, the sequence can be implemented to address every fifth row of the array of the display elements 150 in sequence.

In some implementations, the addressing process for loading image data to the array of display elements 150 is separated in time from the process of actuating the display elements. In such an implementation, the array of display elements 150 may include data memory elements for each display element, and the control matrix may include a global actuation interconnect for carrying trigger signals, from the common driver 138, to initiate simultaneous actuation of the display elements according to data stored in the memory elements.

In some implementations, the array of display elements 150 and the control matrix that controls the display elements may be arranged in configurations other than rectangular rows and columns. For example, the display elements can be arranged in hexagonal arrays or curvilinear rows and columns.

The host processor 122 generally controls the operations of the host device 120. For example, the host processor 122 may be a general or special purpose processor for controlling a portable electronic device. With respect to the display apparatus 128, included within the host device 120, the host processor 122 outputs image data as well as additional data about the host device 120. Such information may include data from environmental sensors 124, such as ambient light or temperature; information about the host device 120, including, for example, an operating mode of the host or the amount of power remaining in the host device's power source; information about the content of the image data; information about the type of image data; and/or instructions for the display apparatus 128 for use in selecting an imaging mode.

In some implementations, the user input module 126 enables the conveyance of personal preferences of a user to the controller 134, either directly, or via the host processor 122. In some implementations, the user input module 126 is controlled by software in which a user inputs personal preferences, for example, color, contrast, power, brightness, content, and other display settings and parameters preferences. In some other implementations, the user input module 126 is controlled by hardware in which a user inputs personal preferences. In some implementations, the user may input these preferences via voice commands, one or more buttons, switches or dials, or with touch-capability. The plurality of data inputs to the controller 134 direct the controller to provide data to the various drivers 130, 132, 138 and 148 which correspond to optimal imaging characteristics.

The environmental sensor module 124 also can be included as part of the host device 120. The environmental sensor module 124 can be capable of receiving data about the ambient environment, such as temperature and or ambient lighting conditions. The sensor module 124 can be programmed, for example, to distinguish whether the device is operating in an indoor or office environment versus an outdoor environment in bright daylight versus an outdoor environment at nighttime. The sensor module 124 communicates this information to the display controller 134, so that the controller 134 can optimize the viewing conditions in response to the ambient environment.

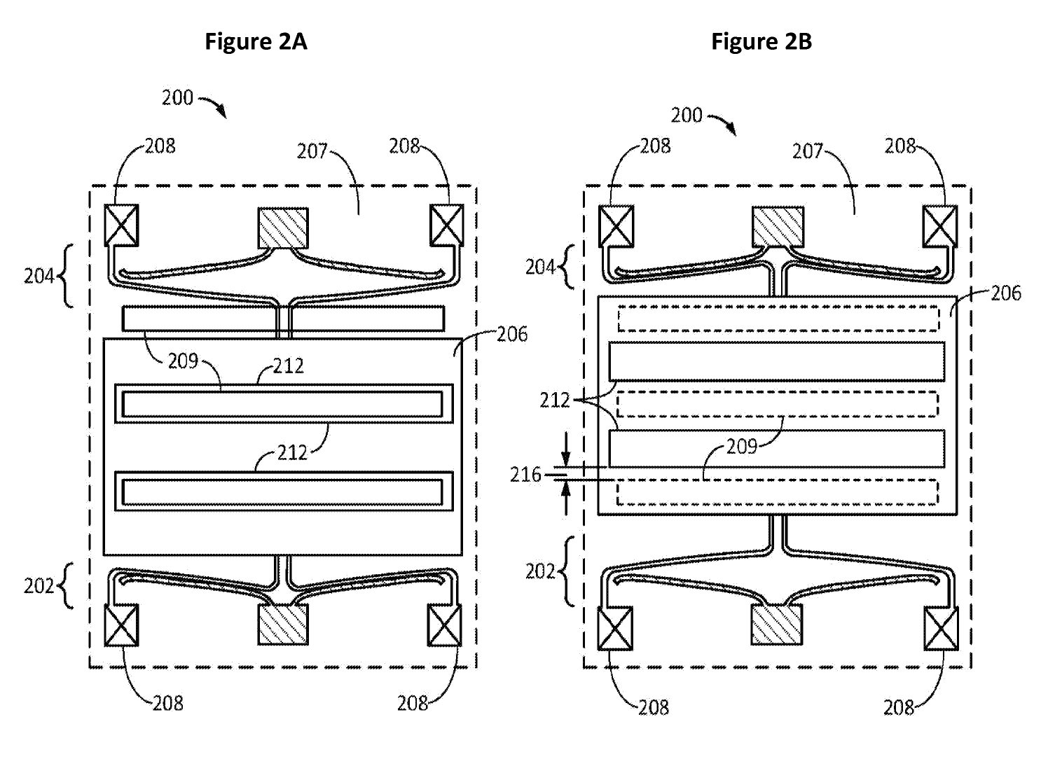

FIGS. 2A and 2B show views of an example dual actuator shutter assembly 200. The dual actuator shutter assembly 200, as depicted in FIG. 2A, is in an open state. FIG. 2B shows the dual actuator shutter assembly 200 in a closed state. The shutter assembly 200 includes actuators 202 and 204 on either side of a shutter 206. Each actuator 202 and 204 is independently controlled. A first actuator, a shutter-open actuator 202, serves to open the shutter 206. A second opposing actuator, the shutter-closed actuator 204, serves to close the shutter 206. Each of the actuators 202 and 204 can be implemented as compliant beam electrode actuators. The actuators 202 and 204 open and close the shutter 206 by driving the shutter 206 substantially in a plane parallel to an aperture layer 207 over which the shutter is suspended. The shutter 206 is suspended a short distance over the aperture layer 207 by anchors 208 attached to the actuators 202 and 204. Having the actuators 202 and 204 attach to opposing ends of the shutter 206 along its axis of movement reduces out of plane motion of the shutter 206 and confines the motion substantially to a plane parallel to the substrate (not depicted).

In the depicted implementation, the shutter 206 includes two shutter apertures 212 through which light can pass. The aperture layer 207 includes a set of three apertures 209. In FIG. 2A, the shutter assembly 200 is in the open state and, as such, the shutter-open actuator 202 has been actuated, the shutter-close actuator 204 is in its relaxed position, and the centerlines of the shutter apertures 212 coincide with the centerlines of two of the aperture layer apertures 209. In FIG. 2B, the shutter assembly 200 has been moved to the closed state and, as such, the shutter-open actuator 202 is in its relaxed position, the shutter-closed actuator 204 has been actuated, and the light blocking portions of the shutter 206 are now in position to block transmission of light through the apertures 209 (depicted as dotted lines).

Each aperture has at least one edge around its periphery. For example, the rectangular apertures 209 have four edges. In some implementations, in which circular, elliptical, oval, or other curved apertures are formed in the aperture layer 207, each aperture may have a single edge. In some other implementations, the apertures need not be separated or disjointed in the mathematical sense, but instead can be connected. That is to say, while portions or shaped sections of the aperture may maintain a correspondence to each shutter, several of these sections may be connected such that a single continuous perimeter of the aperture is shared by multiple shutters.

In order to allow light with a variety of exit angles to pass through the apertures 212 and 209 in the open state, the width or size of the shutter apertures 212 can be designed to be larger than a corresponding width or size of apertures 209 in the aperture layer 207. In order to effectively block light from escaping in the closed state, the light blocking portions of the shutter 206 can be designed to overlap the edges of the apertures 209. FIG. 2B shows an overlap 216, which in some implementations can be predefined, between the edge of light blocking portions in the shutter 206 and one edge of the aperture 209 formed in the aperture layer 207.

The electrostatic actuators 202 and 204 are designed so that their voltage-displacement behavior provides a bi-stable characteristic to the shutter assembly 200. For each of the shutter-open and shutter-close actuators, there exists a range of voltages below the actuation voltage, which if applied while that actuator is in the closed state (with the shutter being either open or closed), will hold the actuator closed and the shutter in position, even after a drive voltage is applied to the opposing actuator. The minimum voltage needed to maintain a shutter's position against such an opposing force is referred to as a maintenance voltage Vm.

Display devices may utilize a stack of optical films that are interposed between the shutter mechanisms, or other display pixel layer mechanisms, used and the light source. In various implementations discussed herein, the light source is treated as part of the optical stack for discussion purposes. It is to be understood that reference to “optical stack” may include implementations including a stack of optical films and a light source as well as implementations including a stack of optical films without a light source; in the latter case, the optical stack may be combined with a light source at a later time. For example, an optical film manufacturer may sell an optical stack that includes an arrangement of optical films as discussed herein, and the purchaser of such an optical stack may then combine the optical stack with a light source to create a BLU.

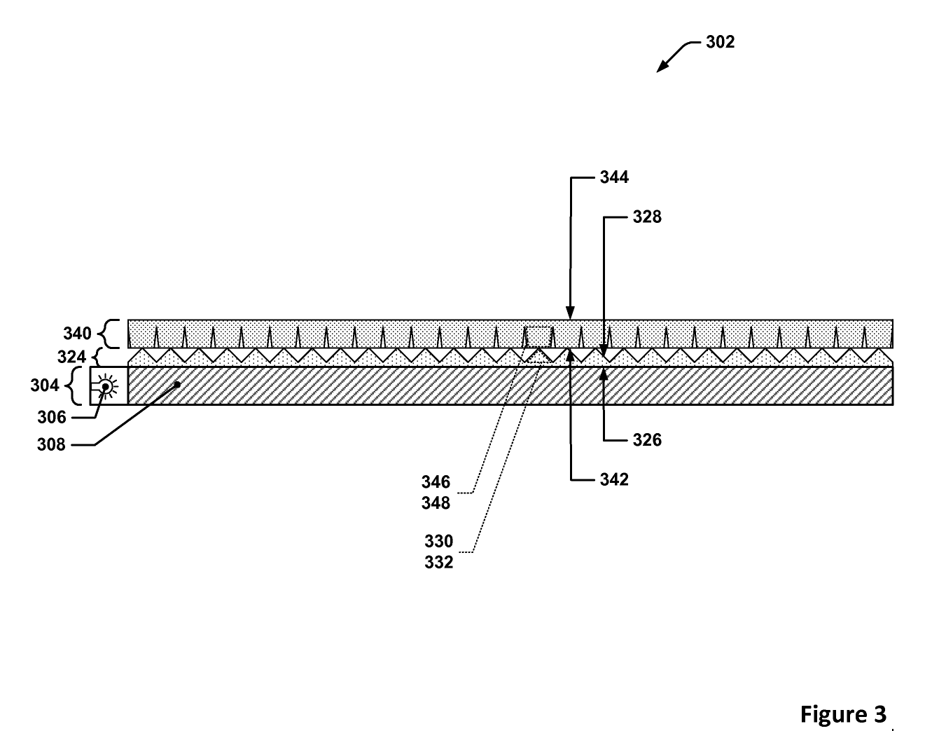

The following sections discuss in more detail various configurations of optical stacks in line with the concepts outlined herein. FIG. 3 depicts a side cross-sectional view of an optical stack arrangement for an example display. Visible in FIG. 3 is an optical stack 302, which includes a several layers—a light source 304, a first optical film 324, and a second optical film 340. The light source 304, as shown, includes an edge-located lamp 306 and a light guide 308; the light guide 308 may include light-turning structures or features that cause the light that travels in a predominantly horizontal direction, with respect to the orientation of the drawing, to be redirected so as to exit the upper, with respect to the orientation of the drawing, surface of the light guide 308.

The first optical film 324 is a sawtooth profile optical film, such as the 3M™ Vikuiti BEF II™ film or similar optical films offered by companies such as E-FUN and Gamma Optical, which make optical films that are generally prismatic in nature but that may also incorporate diffusive elements as well (which may also be used for the first optical film and the like), that is overlaid on the light guide 308 such that light that exits the upper surface of the light guide 308 is directed into the first optical film 324. The first optical film 324 may include two opposing surfaces—a first surface 326 and a second surface 328. The first surface 326 of the first optical film 324 may, in some implementations, be flat, and faces the light source 304. The second surface 328 of the first optical film 324 generally has a sawtooth profile. Such a sawtooth profile may be substantially continuous, i.e., each “tooth” may be immediately adjacent to the neighboring “tooth,” without substantial intervening flat portions (portions that are parallel to the overall plane of the optical film, for example). The sawtooth profile formed in the second surface 328 of the first optical film 324 may be thought of as defining a plurality of triangular cross-section, prismatic light-turning structures that are joined by a common base layer. In FIG. 3, one such prismatic light-turning structure 330 is indicated, as is the associated triangular cross-section 332, although it is to be recognized that such prismatic light-turning structures 330, and their associated triangular cross-sections 332, are repeated across the second surface 328 of the first optical film 324. While the prismatic light-turning structures 330 shown are all identical in shape and dimension, it is to be understood that there may be variation between the various prismatic light-turning structures 330. For example, the 3M Company offers the Vikuiti BEF III™ line of products, which feature a randomized sawtooth pattern of prismatic structures having triangular cross-sections that vary slightly in apex angle from prismatic structure to prismatic structure. In some first optical films, the light-turning structures may alternatively or additionally vary slightly in dimensions along their length as well, for example, the apex angle of each prismatic light-turning structure may vary between 88° and 92° along the length of the prismatic light-turning structure. Such randomized-size sawtooth-patterned optical films also may be used to provide the first optical film 324.

The second optical film 340 also may have a first surface 342 and a second surface 344. The first surface 342 of the second optical film 340 may generally face towards the light source 304, and the second surface 344 of the second optical film 340 may face in a direction opposite the first surface 342. The second optical film 340 may include a number of prismatic light-turning structures 346, each having a trapezoidal cross-section 348.

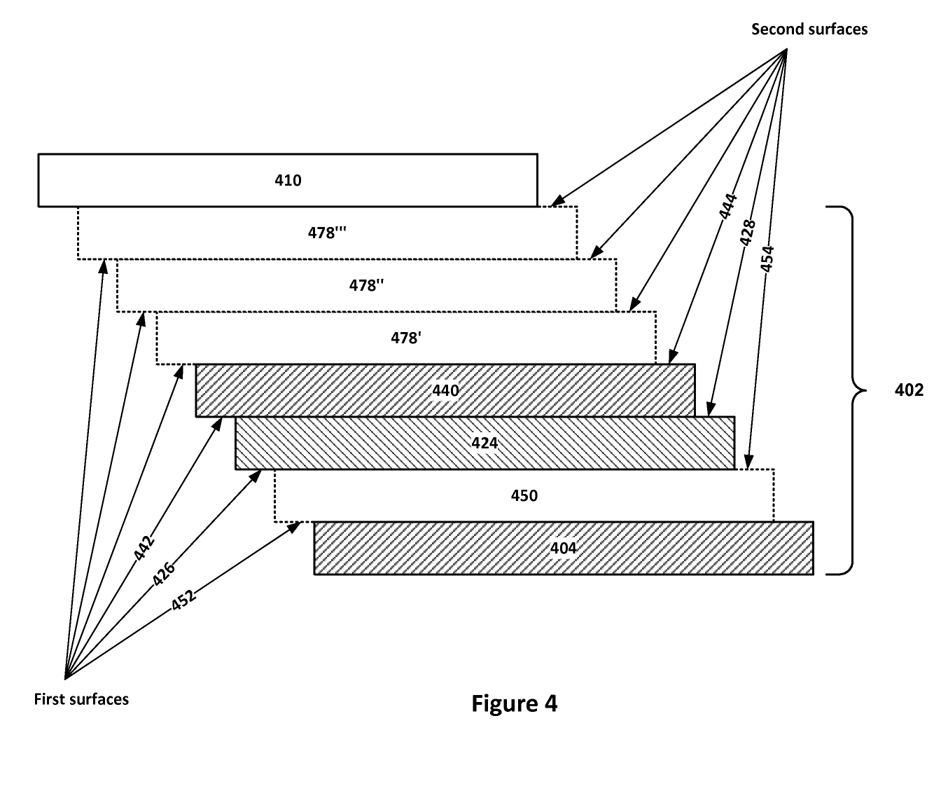

FIG. 4 depicts a side cross-sectional view of an optical stack arrangement for another example display. In this view, the various layers that form an optical stack 402 are depicted in a staggered or offset fashion to allow the first surfaces and second surfaces of each film or layer to be clearly indicated. In practice, the various films and layers forming the stack would generally be coextensive with one another, i.e., aligned with each other.

The basic optical stack arrangement, as discussed above, may include a light source 404, a first optical film 424, and a second optical film 440. Generally speaking, the convention used in this disclosure refers to the surface of each film or layer that faces towards the light source 404 as the “first” surface, and to the surface of each film or layer that faces away from the light source 404, i.e., in a generally opposite direction from the first surface of the corresponding layer, as the “second” surface. Thus, the first optical film 424 may have a first surface 426 and a second surface 428 and the second optical film may have a first surface 442 and a second surface 444. Generally speaking, light may be emitted from the second surface of one optical film and then pass into the adjacent first surface of the adjacent optical film.

As discussed above, the first optical film 424 may have prismatic light-turning structures that form a sawtooth profile in the second surface 428 of the first optical film 424. At the same time, the second optical film 440 may include a multitude of prismatic light-turning structures having a trapezoidal cross section.

The first optical film 424 and the second optical film 440 may be arranged such that the prismatic light-turning structures in each film are arranged so as to be parallel to, orthogonal to, or oblique to the prismatic light-turning structures in the other film.

The optical stack 402 shown may be combined with a display pixel layer 410, which may be an LCD pixel layer or a DMS layer, for example. The display pixel layer 410 may, for example, be a display pixel layer including a plurality of light modulators, such as light modulators 102a, 102b, 102c, and 102d, as depicted in FIG. 1A, or dual shutter assemblies 200, as depicted in FIGS. 2A and 2B.

In some implementations, an additional sawtooth-profile optical film, such as third optical film 450, may be interposed between the first optical film 424 and the light source 404. In such implementations, the third optical film 450 may be oriented such that the triangular cross-section, prismatic light-turning structures of the third optical film 450 are orthogonal to the triangular cross-section, prismatic light-turning structures of the first optical film 424. Similar to the first optical film 424, the third optical film 450 may have a first surface 452 that faces towards the light source 404 and a second surface 454 that is defined by the prismatic light-turning structures of the third optical film 450.

In some additional or alternative implementations, one or more additional optical films 478 with trapezoidal prismatic light-turning structures may be included in the stack such that the second optical film 440 is between the additional optical film(s) 478 and the light source 404. In FIG. 4, three additional optical films 478, 478′, and 478″ are shown, although fewer or greater numbers of such additional optical films may be used. Generally speaking, the second optical film 440 and the one or more additional optical films 478 may act to redirect off-axis light such that it is more on-axis. In some implementations, the more of such optical films that are used, the more on-axis light will pass through the stack.

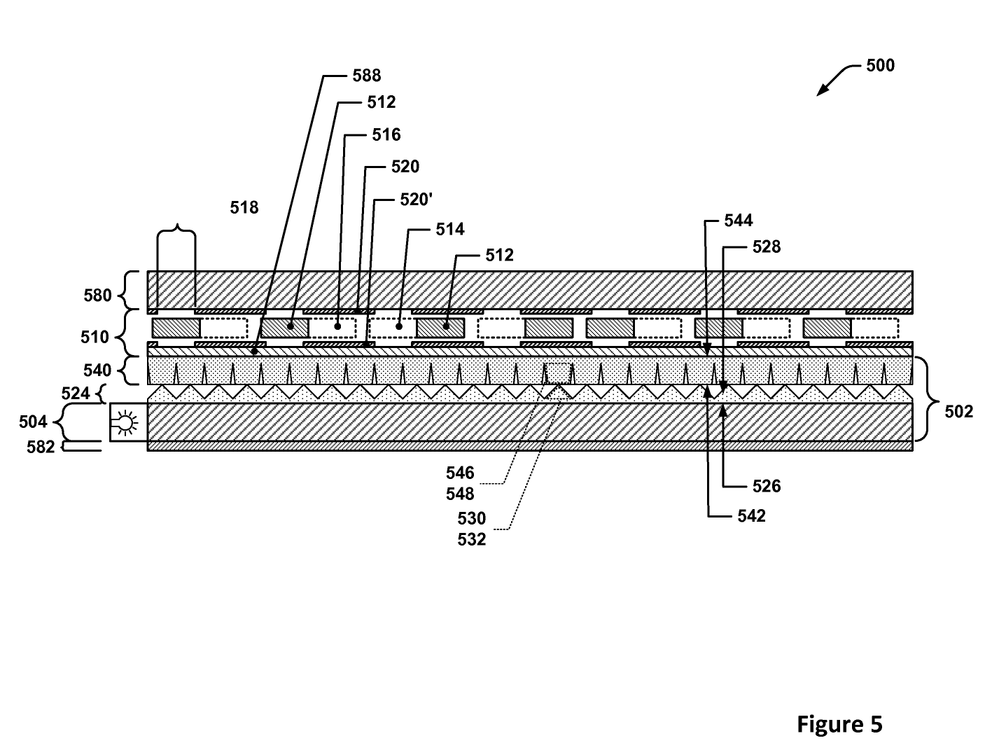

FIG. 5 depicts a side cross-sectional view of an example display. In FIG. 5, a display 500 is shown in cross-section. The display 500 may include a cover plate 580 that may protect the other components shown from dust, moisture, and other physical insult. The cover plate may 580 overlay a display pixel layer 510, which, in this example, includes two aperture plates 520 and 520′. The display pixel layer 510 may, for example, be a display pixel layer including a plurality of light modulators, such as light modulators 102a, 102b, 102c, and 102d, as depicted in FIG. 1A, or dual shutter assemblies 200, as depicted in FIGS. 2A and 2B. The aperture plates 520 and 520′ may each include a number of apertures 518 arrayed across them. A plurality of shutters 512 may be located in between the aperture plates 520 and 520′. Each shutter 512 may be moved between a first position, such as first position 514, and a second position, such as second position 516 (an individual instance of each such position is explicitly indicated with respect to two different shutters 512, but it is to be understood that each shutter 512 may have a corresponding first position 514 and second position 516). When in the corresponding first position 514, a shutter 512 may occlude or block the corresponding aperture 518; when in the corresponding second position 516, a shutter 512 will generally allow light to pass through the corresponding aperture 518.

As shown, the aperture plate 520 is provided as a film interposed between the cover plate 580 and the shutters 512; the other aperture plate 520′ is provided as another film on a transparent substrate 588. The transparent substrate 588 also provides support for the shutters 512 and the shutter drive mechanisms (not shown) that activate the shutters 512. In some other implementations, the shutters 512 and the shutter drive mechanisms may be supported by the cover plate 580.

In some other implementations, the display pixel layer 510 may utilize technology other than DMS technology, such as liquid crystal display technology or any other suitable transmissive light-modulation technology.

The display 500 also includes an optical stack 502, which includes a light source 504, a first optical film 524, and a second optical film 540. In this example, a reflector 582 has also been appended to the optical stack 502 on a side of the light source 504 that faces away from the first optical film 524. The reflector 582 may act to reflect light that emanates from the light source 504 in a direction away from the first optical film 524 to be reflected back through the light source 504 so that it passes into the first optical film 524; this recaptures such light and allows it to be potentially re-directed towards a person viewing the display 500, thus increasing display brightness.

The first optical film 524 may have a first surface 526 that faces towards the light source 504, and a second surface 528 that faces away from the light source 504. The second surface 528 of the first optical film 524 may be defined by a plurality of triangular cross-section, prismatic light-turning structures 530. A triangular cross-section 532 of one of these prismatic light-turning structures 530 is shown, although similar cross-sections may define further prismatic light-turning structures 530 across the extent of the first optical film 524.

The second optical film 540 may include a first surface 542 that faces towards the light source 504 and the first optical film 524, as well as a second surface 544, which faces away from the first optical film 524 and the light source 504. The second optical film 540 also may include a plurality of trapezoidal cross-section, prismatic light-turning structures 546. As indicated, each of the prismatic light-turning structures 546 may be defined by a trapezoidal cross-section 548.

Generally speaking, the first optical film 524 may have the effect of causing the intensity v. viewing angle curve of the light from the light source 504 that passes through the first optical film 524 to shift such that the peak intensity in this curve occurs at a viewing angle that is closer to normal to the display 500. In contrast, the second optical film 540 may have the effect of increasing the peak, while at the same time narrowing the width, of the intensity v. viewing angle curve without causing a significant shift in the viewing angle associated with the peak intensity. This is particularly useful with DMS display technology, as the higher on-axis intensity ensures that more light passes through the apertures without striking the side walls of the apertures or the shutters, resulting in a more-luminous display 500.

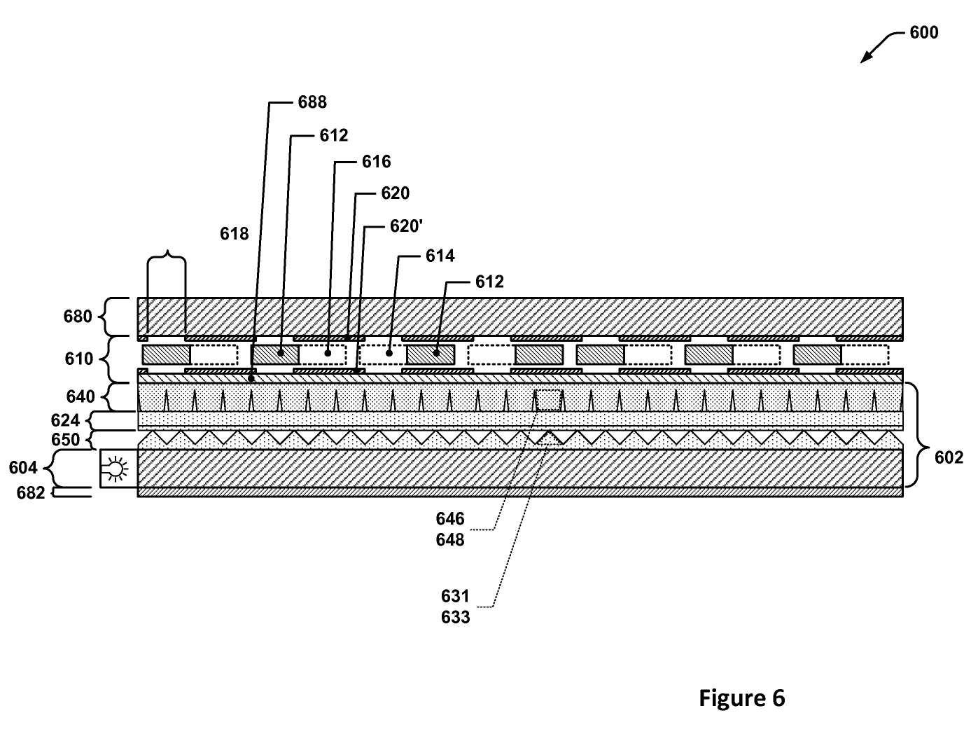

FIG. 6 depicts a side cross-sectional view of another example display. The display 600 shown in FIG. 6 is, in many respects, similar to that shown in FIG. 5, and, for brevity, structures in FIGS. 6 and 5 that are the same are numbered with the same last two digits in both Figures and are not described again since the descriptions provided above with respect to FIG. 5 may be generally applied to the corresponding components in FIG. 6.

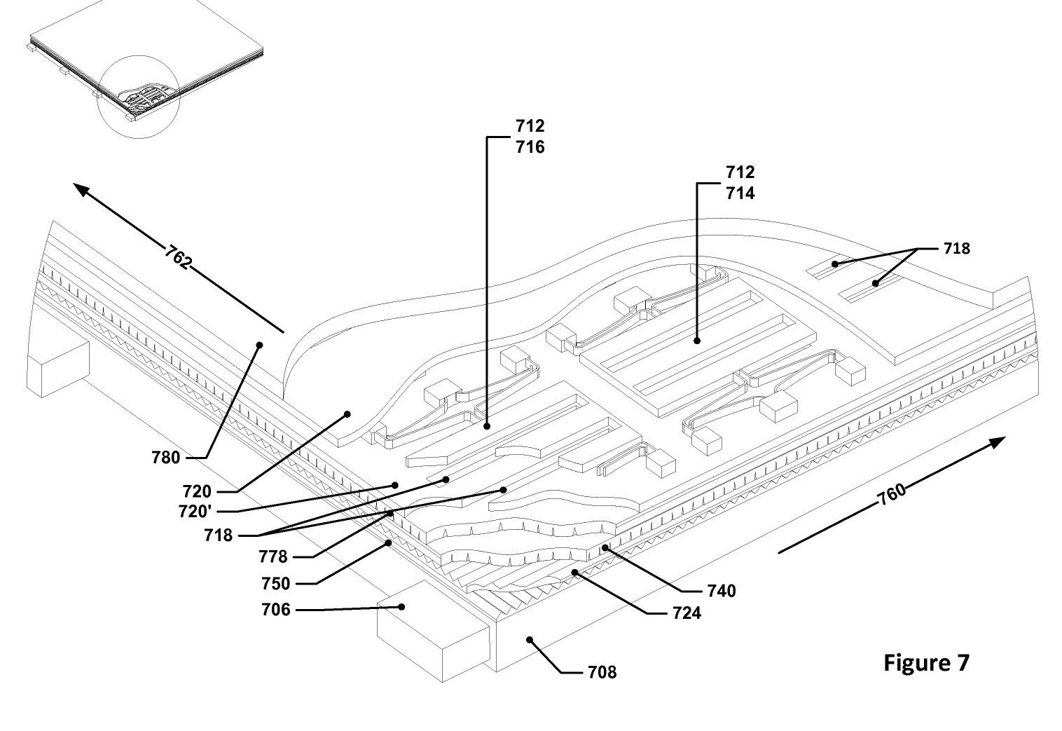

In contrast to the display 500 of FIG. 5, the display 600 of FIG. 6 includes a third optical film 650 that is interposed between the first optical film 624 and the light source 604 to form an optical stack 602. The third optical film 650, as shown, is the same as the first optical film 624, but is rotated such that triangular cross-section 633, prismatic light-turning structures 631 of the third optical film 650 are aligned along a first direction that is substantially orthogonal to a second direction along which the triangular cross-section, prismatic light-turning structures of the first optical film 624 are aligned. As can be seen, the first optical film 624 is oriented differently in FIG. 6 as compared with the first optical film 524 in FIG. 5—generally speaking, for a light source that utilizes a light guide element of some sort, the prismatic optical film that is closest to the light guide element may be oriented such that the prismatic elements are oriented with their long axes generally perpendicular to the primary direction of light propagation within the light guide element. Additionally, there may be other types of optical films, which are not shown here, that may be placed in the optical stack. For example, a diffuser film, which typically includes a random pattern of non-prismatic, light-dispersion elements, may be interposed between the light source and the first and/or third optical films or may be interposed between the first and the third optical films (if both are used). As such, the sawtooth profile of the first optical film 624 is not visible in FIG. 6 since this sawtooth profile is viewed along a direction parallel to the sawtooth profile section plane. This relationship may be more clearly seen in FIG. 7, which depicts a view of another example display that also includes a first optical film and a third optical film that are crossed with respect to one another.

FIG. 7 depicts an off-angle, three-dimensional cutaway view of an example display. The cutaway view shown is a detail of one corner of a display 700, this corner is circled for reference. It is to be understood that the display 700, as well as the components shown in FIG. 7, are not drawn to scale—the detail provided is merely provided to give some sense of various characteristics of the structures shown.

The display 700 may include a cover plate 780, a display pixel layer (not separately indicated) that includes aperture plates 720 and 720′ as well as shutters 712, and an optical stack (not separately indicated) that includes a light source provided by a lamp 706 operating in conjunction with a light guide 708 as well as a first optical film 724, a second optical film 740, a third optical film 750, and an additional optical film 778.

As can be seen, the shutters 712 may be moved between at least two positions—a first position 714 and a second position 716. In the first position 714, the shutter 712 blocks corresponding apertures 718 formed in the aperture plates 720 and 720; in the second position 716, the shutter 712 may allow light to pass through the corresponding apertures 718. The shutters shown are driven by mechanisms similar to those used to drive the shutters in the shutter assembly 200 of FIGS. 2A and 2B.

As can be seen, FIG. 7 provides a three-dimensional view of the display 700 where decreasingly-sized portions of successive layers of the display 700 have been cut away to allow for clearer viewing of the features within the display 700. It is to be understood that this cutaway presentation is to facilitate better understanding of the example display 700 and that such cutaway features do not form an actual part of the structure.

The first optical film 724 and the third optical film 750, as shown, may be arranged in a manner that causes the triangular cross-section, prismatic light-turning structures that form the second surface of the first optical film 724 to be oriented such that they are aligned with a first direction 760 that is orthogonal to a second direction 762 with which the triangular cross-section, prismatic light-turning structures that form the second surface of the third optical film 750 are aligned. The first surfaces, second surfaces, and prismatic light-turning structures of each optical film discussed in this example are not called out in FIG. 7 to avoid undue visual clutter and since such surfaces and structures are readily identifiable based on other figures and examples discussed in this disclosure.

In this example, as mentioned above, there is an additional optical film 778. The additional optical film 778 is, like the second optical film 740, an optical film that includes trapezoidal cross-section, prismatic light-turning structures. The additional optical film 778, in this case, has prismatic light-turning structures that are aligned with the first direction 760 and the second optical film 740 has prismatic light-turning structures that are aligned with the second direction 762. It is to be understood that the particular orientations shown may be altered in other implementations, for example, the first optical film 724 and the second optical film 740, while shown having prismatic light-turning structures that are orthogonal to one another, also may be provided such that the prismatic light-turning structures of the first optical film 724 are parallel to the prismatic light-turning structures of the second optical film 740. In some implementations, the relative orientations of the adjacent optical films used may be at a non-orthogonal, i.e., oblique, angle or such adjacent optical films may be arranged such that their prismatic light-turning structures are parallel to one another.

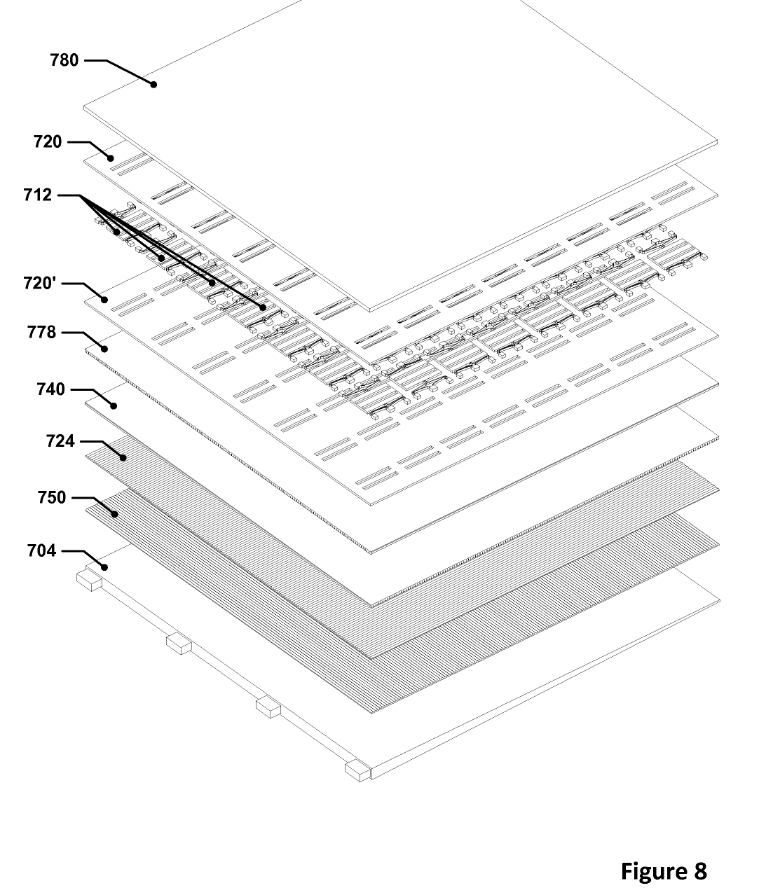

FIG. 8 depicts a three-dimensional exploded view of the example display of FIG. 7. As can be seen, the display 700 is a 7x8 pixel display—in actual practice, the display 700 may have thousands or millions of such pixels.

While the above discussion has focused primarily on the relative arrangement of the first and second, as well as third and additional, if used, optical films in the optical stack, the following discussion provides further insight as to the particulars of the optical films and prismatic light-turning structures that are appropriate for such optical films. These are merely some examples of such optical films, and it will be understood that additional examples not discussed explicitly herein may nonetheless fall within the scope of this disclosure, consonant with the details provided herein. It is to be further understood that any discussion herein of the details of a first optical film may apply equally to the features and characteristics of a third optical film as well. Correspondingly, any discussion herein of the details of a second optical film may apply equally to the features and characteristics of one or more additional optical films as well. As used herein, the term “additional optical film” is to be understood as referring to optical films with trapezoidal cross-section, prismatic light-turning structures; this term is not used to refer to optical films with triangular cross-section, prismatic light-turning structures forming sawtooth profiles.

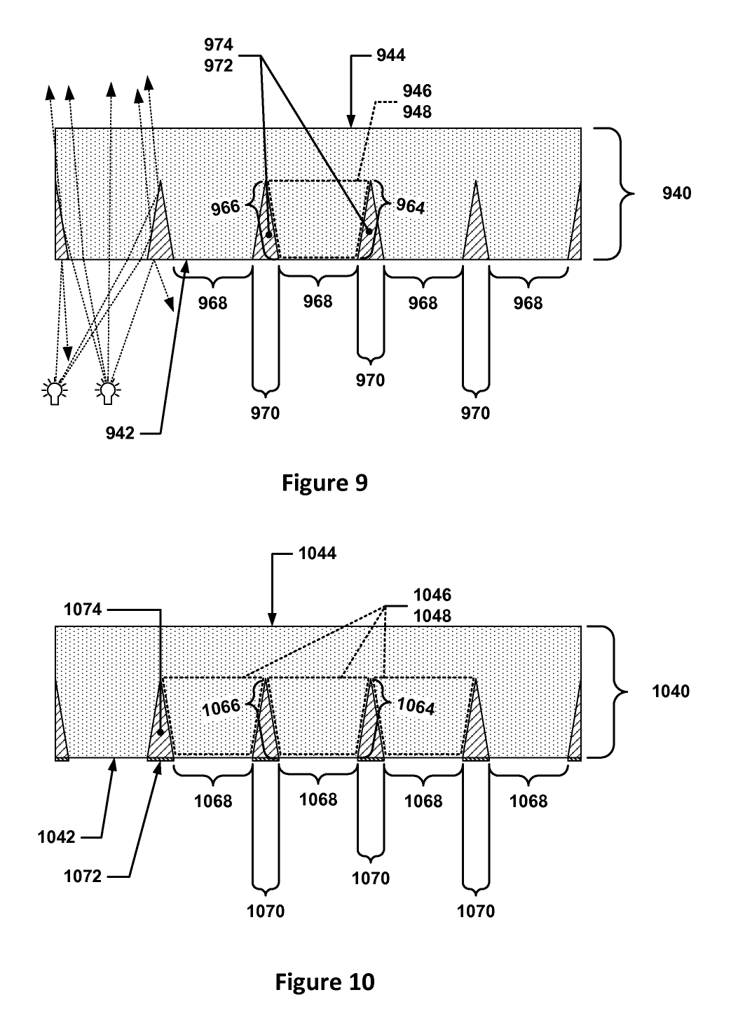

FIG. 9 depicts a side section view of one example of a second optical film that uses V-shaped grooves to provide light-turning structures. In FIG. 9, a second optical film 940 is shown. The second optical film 940 may be made from an optically transparent material, such as polyethylene and/or acrylic resin, and may feature a plurality of trapezoidal cross-section 948, prismatic light-turning structures 946. The trapezoidal cross-section 948 of the prismatic light-turning structures 946 may be defined by a first sloped wall portion 964 and a second sloped wall portion 966, as well as by a base portion 968. The remaining portion of the trapezoidal cross-section 948 may be defined by another base portion (not called out) that extends from the ends of the first sloped wall portion 964 and the second sloped wall portion 966 that are distal from the base portion 968; this other base portion may generally be wider than the base portion 968, causing the trapezoidal cross-section 948 to widen with increasing distance from the light source (not shown).

The first sloped wall portion 964 and the corresponding second sloped wall portion 966 of each prismatic light-turning structure 946 may form an angle between them. In some implementations, this angle may be between 5 and 45 degrees, between 5 and 15 degrees, or approximately 10 degrees.

The second optical film 940 may include a first surface 942 and a second surface 944. In the depicted implementation, a plurality of V-shaped grooves 974 have been formed in the first surface 942 of the second optical film 940; these V-shaped grooves may be formed by etching, thermoforming, or other technique, and may then be coated or filled with a different material than that which forms the bulk of the second optical film 940. The material that is used to coat or fill the V-shaped grooves may be selected to cause reflection of light that strikes the first sloped wall portions 964 or the second sloped wall portions 966 at an oblique angle. This material may, for example, be a reflective metal or other opaque, reflective material, or may be a translucent or transparent material that has a lower index of refraction than the index of refraction of the material that forms the bulk of the second optical film 940. For example, the second optical film 940 may be formed from a material having an index of refraction of 2.5, and the V-shaped grooves 974 may be filled or coated with a material having an index of refraction of 1.5. In an implementation using such indices of refraction, light that strikes the first sloped wall portion 964 or the second sloped wall portion 966 at an angle of approximately 53 degrees or less to the wall portion will undergo total internal reflection. Thus, the V-shaped grooves 974 may, in such implementations, act as opaque mirrors for most light that strikes the sloped wall portions defined by the V-shaped grooves 974 even though the material used to coat or fill such V-shaped grooves 974 may be transparent.

Also visible in FIG. 9 are interstitial portions 970, which are located in between each pair of adjacent base portions 968. The interstitial portions 970 may act as a mirrored recycling surface when the V-shaped grooves 974 are filled with reflective material, as is done in this depicted example. Light that strikes such mirrored recycling surfaces may be reflected back towards the light source and may reflect off of other surfaces, such as a reflector sheet placed on the opposite side of the light source from the optical films, until it re-enters the second optical film 940 at a different location, such as one of the base portions 968, and is directed out of the second surface 944 of the second optical film 940.

On the left side of FIG. 9 are two light-bulb symbols representing origination points for several light rays, which are represented by dotted-line arrows. In actual practice, the “origination points” may be locations on the second surface of a first optical film (or other adjacent optical film) where light exits the first optical film (or other adjacent optical film). For discussion purposes, the angles between an axis that is normal to the second optical film 940, i.e., a vertical axis from the perspective of FIG. 9, and the first sloped wall portion 964 and the second sloped wall portion 966 may be referred to as the “included angles.”

As can be seen, the light that enters the prismatic light-turning structures 946 within the base portion 968 and at an angle from the “vertical” axis in FIG. 9 that is less than the included angle may generally pass through the second optical film 940 without reflecting off of any surfaces. Such light may nonetheless still undergo refraction as it crosses the boundaries represented by the first surface 942 and the second surface 944 of the second optical film 940.

Light that enters the base portion 968 at an angle from the “vertical” axis that is greater than the included angle may, in many cases, strike either the first sloped wall portion 964 or the second sloped wall portion 966. Such light may then be reflected by the first sloped wall portion 964 or the second sloped wall portion 966 such that the light is at a smaller angle with respect to the “vertical axis.” In implementations where the sloped wall portions are not coated or backed by an opaque reflective coating but instead by a transparent material having a lower index of refraction than the bulk material of the second optical layer, light that strikes the sloped wall portions at an angle off of “vertical” that is sufficiently high enough may cause such light to undergo partial internal reflection as opposed to total internal reflection; the reflected portion of such light may thus be redirected so as to be more on-axis with respect to the “vertical” axis.

Light that strikes the interstitial portions 970 may, as shown, reflect back towards the light source in implementations where the interstitial portion includes a reflective coating or material.

FIG. 10 depicts a side section view of one example of another second optical film that uses V-shaped grooves to provide light-turning structures.

The second optical film 1040 shown in FIG. 10 is, in many respects, similar to that shown in FIG. 9, and, for brevity, structures in FIGS. 10 and 9 that are the same are numbered with the same last two digits in both Figures and are generally not described again since the descriptions provided above with respect to FIG. 9 may be applied to the corresponding components in FIG. 10.

The chief difference between the second optical film 940 of FIG. 9 and the second optical film 1040 of FIG. 10 is that the first surface 1042 of the second optical film 1040 has had a pattern of reflective material 1072 applied in the interstitial portions 1070. Thus, the V-shaped grooves 1074 may be filled with a transparent material having a lower index of refraction than the bulk material of the second optical film 1040, but the interstitial portions 1070 may have an opaque reflective coating that reflects incident light back towards the light source. It is to be understood that while the V-shaped grooves that are depicted taper to sharp points, the V-shaped grooves also may be truncated to form trapezoidal shapes as well.

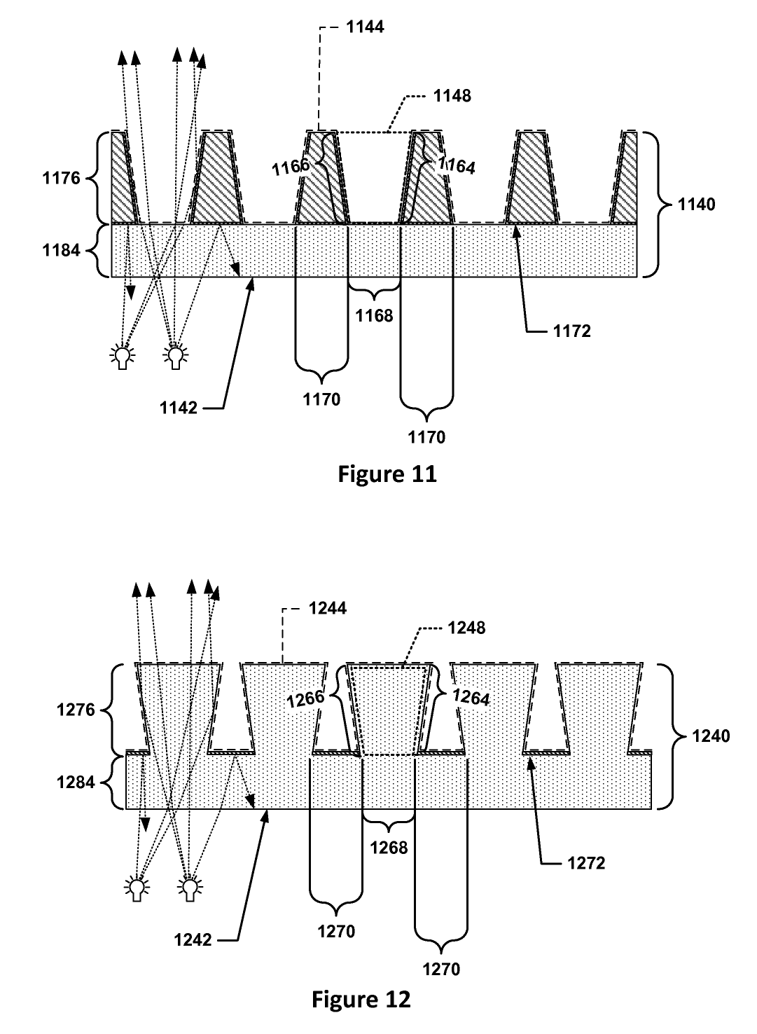

FIG. 11 depicts a side section view of one example of a second optical film that uses protrusions to provide light-turning structures having trapezoidal cross-sections 1148. FIG. 11 depicts a second optical film 1140 that includes a base layer 1184 and a series of protrusions 1176. The protrusions 1176 shown are trapezoidal in nature but also may be triangular in shape, if desired—in both cases, the protrusions 1176 define a first sloped wall portion 1164 and a second sloped wall portion 1166. The space between each pair of adjacent protrusions 1176 defines a base portion 1168, and the base of each protrusion 1176 defines an interstitial portion 1170. It is to be understood that the light reflection that may occur with respect to the light-turning structures discussed herein may occur within the material of the light-turning structure itself, such as is the case with the second optical films 940 and 1040, or may occur within an air gap bounded by the light-turning structures, as is the case with the second optical films 1140 and 1240.

As can be seen, the second surface 1144 of the second optical film 1140 is not a smooth surface, but is instead largely defined by the protrusions 1176 (the second surface 1144 is shown as a dashed outline slightly offset from the actual second surface 1144 for enhanced clarity) and has a somewhat square-wave-shaped pattern. The protrusions 1176 may be made from a reflective material or, as is shown, coated in a reflective material 1172.

As can be seen by the light origination points and dotted light rays shown on the left side of FIG. 11, the second optical film 1140 has light-reflection characteristics similar to that of the second optical films 940 and 1040.

To give some sense of scale, one implementation of the second optical film 1140 may have first sloped wall portions 1164 and second sloped wall portions 1166 that are each at 85° with respect to the first surface 1142. In such an implementation, the base portions 1168 and the interstitial portions 1170 may both be approximately 40 μm wide, and the height of the protrusions 1176 may be approximately 115 μm. In some other implementations, the base portions may be larger or smaller in width than the interstitial portions, in contrast to the arrangement in this example, where the base portions 1168 and the interstitial portions 1170 are equal in width.

FIG. 12 depicts a side section view of another example of a second optical film that uses protrusions to provide light-turning structures. In FIG. 12, a second optical film 1240 is depicted. As with the second optical film 1140, the second optical film 1240 has a base layer 1284 and a series of keystone-shaped protrusions 1276. Each protrusion 1276 forms a trapezoidal cross-section 1248 that provides a prismatic light-turning structure. A reflective material 1272 may be applied to interstitial portions 1270 between each protrusion 1276; this reflective material may reflect incident light back towards a first surface 1242 of the second optical film 1240. Light that passes through base portions 1268, which are located between the interstitial portions 1270, may pass out of the second surface 1244 (shown offset slightly from the actual second surface) of the second optical film 1240—either directly or after reflecting off of either the first sloped wall portion 1264 or the second sloped wall portion 1266. In such an implementation, an index of refraction mismatch between the material used to make the protrusion 1276 and the air (or other gas) occupying the spaces between each protrusion 1276 may be used to cause total internal reflection to occur at the first sloped wall portion 1264 and the second sloped wall portion 1266.

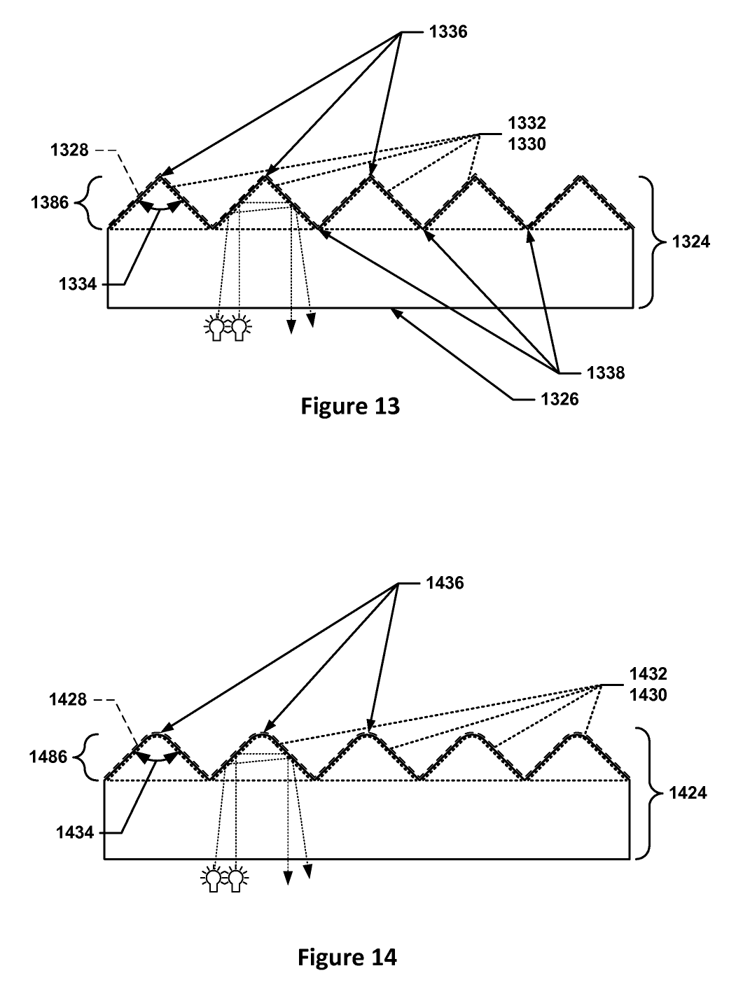

FIG. 13 depicts a side section view of an example first optical film. As seen in FIG. 13, a first optical film 1324 may include a repeating pattern of triangular cross-section 1332, prismatic light-turning structures 1330. These prismatic light-turning structures 1330 may define a sawtooth profile 1386 that is defined by peaks 1336 and valleys 1338 formed by the prismatic light-turning structures 1330. The peaks 1336 may be formed by an apex angle 1334 which may, in many implementations, be 90°. In various other implementations, however, the apex angle may be varied slightly from 90°, such as 90°±5° or 88° to 92°. It is to be understood that the features discussed above with respect to the first optical film 1324 also may be applicable to a third optical film, as discussed with respect to the previous implementations. Generally speaking, in implementations where a first optical film and a third optical film are used, the two optical films may have identical characteristics aside from their relative orientations (if the two optical films used for a first optical film and a third optical film are both optical films with slightly randomized apex angles or other characteristics, then such films will not be exact duplicates, although both may be viewed as functionally interchangeable and as having identical characteristics).

As discussed previously, the first optical film 1324 may have a first surface 1326 and a second surface 1328 that is defined by the prismatic light-turning structures 1330.

For reference, two light origination points are indicated in FIG. 13 by way of lightbulb icons, and two light rays that emanate from these points are shown—as can be seen, light that is substantially on-axis with respect to a “vertical” axis with respect to the orientation of FIG. 13 may be reflected back towards the light source by way of total internal reflection. Other light (not shown) that is more off-axis may be transmitted through the first optical film 1324 without undergoing total internal reflection and may, due to refraction, be redirected to be more on-axis upon exiting the first optical film 1324.

FIG. 14 depicts a side section view of another example first optical film. As can be seen, the first optical film 1424 may include a series of prismatic light-turning structures 1430 each having a substantially triangular cross-section 1432. In contrast to the prismatic light-turning structures 1330 of FIG. 13, the prismatic light-turning structures 1430 each have a “rounded” upper edge that forms peaks 1436 and thus do not form a sharp “peak” as shown in FIG. 13. Nonetheless, each prismatic light-turning structure 1430 still has an overall cross-sectional shape that may still be described as substantially triangular, and the prismatic light-turning structures 1430 may form a sawtooth profile 1486 that defines a second surface 1428 of the example first optical film 1424. The triangular cross-section 1432 of each such prismatic light-turning structure 1430 also may be defined by an apex angle 1434, which may be evaluated based on the included angle between the portions of each prismatic light-turning structure 1430 that are nominally straight and that abut the peaks 1436.

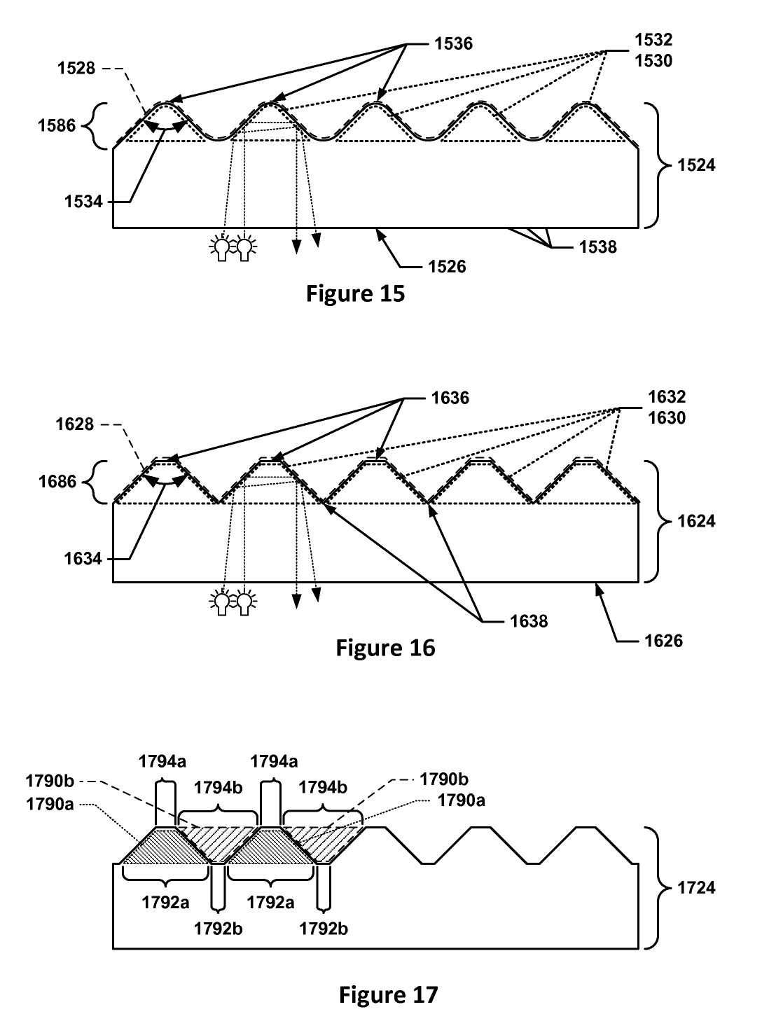

FIG. 15 depicts a side section view of yet another example first optical film. As can be seen, the first optical film 1524 may include a series of prismatic, light-turning structures 1530 that have both rounded peaks 1536 and rounded valleys 1538. Again, however, the prismatic light-turning structures 1530 have what may be referred to as substantially triangular cross-sections 1532 despite the rounding of the peaks 1536 and the valleys 1538. The substantially triangular cross-sections 1532 cause a sawtooth profile 1586 to be formed in the second surface 1528 of the first optical film 1524, opposite the first surface 1526 of the first optical film 1524. Again, an apex angle 1534 may be formed by the nominally straight surfaces of the prismatic light-turning structures 1530 that adjoin each peak 1536.

FIG. 16 depicts a side section view of yet another example first optical film. As can be seen, the first optical film 1624 includes prismatic light-turning structures 1630 that have nominally triangular cross-sections 1632. In this particular example, the prismatic light-turning structures 1630 have flat tops, forming, in effect, a trapezoid, although the overall shape of the prismatic light-turning structure 1630 is still generally triangular. The nominally triangular cross-sections 1632 may form a sawtooth (or blunted sawtooth) profile 1686 that defines a second surface 1628 of the first optical film 1624. The sloped sidewalls of each prismatic light-turning structure 1630 may, as with the other prismatic light-turning structures for first optical films discussed above, be angled such that they define an apex angle 1634.

It is to be understood that the light-turning structure 1630, while perhaps technically forming a trapezoidal cross-section, is distinct from the trapezoidal cross-section light-turning structures utilized in the second and additional optical films discussed earlier. For example, one key difference is in the apex angle 1634 (this applies generally to all of the first and third optical films discussed herein)—the apex angle 1634 of the first and third optical films is typically approximately 90 degrees. While some variation from this standard may occur, such deviation typically ranges from about −10 degrees (80 degrees apex angle) to about +5 degrees (95 degrees apex angle). In contrast, the included angle between the sloped wall portions of trapezoidal cross-section, prismatic light-turning structures, such as are discussed herein with respect to second and additional optical films, is typically in the 10-30 degree range, although it may range all the way up to approximately 45 degrees in some cases.

Another key difference is between the “optical cavities” of the prismatic light-turning structures. The term “optical cavity” is used herein to refer to the portion of each prismatic light-turning structure within which light is generally caused to change direction; the optical cavity corresponds, in the Figures used herein, to the dotted lines used to indicate the “cross sections” of each prismatic light-turning structure. The optical cavity may, depending on the light-turning structure, be located within the material of the optical film (such as in FIGS. 9, 10, 13-16, and part of FIG. 17) or may be located in an air gap between various reflecting surfaces (such as in, for example, FIGS. 11 and 12, as well as part of FIG. 17). In the optical cavity for each trapezoidal cross-section light-turning structure used in the second optical film or the additional optical film(s), the “base” of that optical cavity that is closer to the light source is wider than the base of that optical cavity that is further from the light source (with the phrase “base” referring generally to the portions of each optical cavity that are nominally parallel to one another). In contrast, the “bases” of the optical cavities for the light-turning structures 1630 that are closer to the light source are each wider than the bases of those optical cavities that are further from the light source.

FIG. 17 depicts a side section view of another example of a first optical film. In FIG. 17, a first optical film 1724 is depicted. The first optical film 1724 has a series of prismatic light-turning structures (not separately called out here) similar to those depicted in FIG. 16, except that the depicted prismatic light-turning structures not only have flat “peaks” but also flat “valleys.” This results in two different types of optical cavities 1790 being formed—optical cavities 1790a, which are formed within the material of the prismatic light-turning structures, and optical cavities 1790b, which are formed in the air spaces between adjacent optical cavities 1790a. Due to the flat peaks/flat valleys in this example first optical film 1724, both types of optical cavity 1790, while substantially triangular, have actual shapes that may be described as trapezoidal. For the purposes of this disclosure, these two optical cavity types may be referred to as “dominant” and “non-dominant” optical cavities. Each dominant optical cavity, for example, optical cavity 1790a, has a first base width, for example, first base width 1792a, that is larger than the first base widths, for example, first base widths 1792b, of the adjacent optical cavity or cavities, for example, optical cavity 1790b. Non-dominant optical cavities, for example, optical cavities 1790b, have first base widths, for example, first base widths 1792b, which are smaller than the first base widths, for example, first base widths 1792a, of the adjacent optical cavity or cavities, for example, optical cavity 1790a. The term “dominant” is used for optical cavities 1790a since far more light is able to enter the optical cavity via the first base of the dominant optical cavity than can enter the non-dominant optical cavity via its corresponding first base—as such, far more light passes through the dominant optical cavities than the non-dominant optical cavities, allowing the dominant optical cavities to be the primary source of light redirection within the first optical film 1724.

It is to be understood that the optical films discussed herein, including the first, second, third, and additional optical films, may be manufactured out of materials commonly used for optical films, including, but not limited to, polyethylene and/or acrylic resin. If second and additional optical films are used that incorporate, for example, V-shaped grooves or other light-turning structures, a material such as SiO₂ may be used to fill the grooves and provide a different index of refraction as compared with the index of refraction of the bulk material of the optical film. If two transparent materials of different indices of refraction are used to provide total internal reflection, then Al, Ag, TiOₓ, NbOₓ, SiNₓ, etc. coatings may be applied to the interstitial portions as reflective materials for light-recycling purposes. It is also possible to use such materials to fill such grooves or other structures (instead of using a transparent material with an index of refraction mismatch).

It is also to be understood that, as discussed previously with respect to the first optical film, the second optical film, third optical film, and the additional optical films discussed herein, the prismatic light-turning structures in each such film may vary slightly from light-turning structure to light-turning structure within the film and/or along the length of the prismatic light-turning structures, i.e., the light-turning structures within a film do not necessarily need to form a perfect, repeating pattern. Some variation is to be expected due to variances in the manufacturing processes used, and some deliberate variation may be engineered into the optical film design to reduce the possibility of geometry-related visual artifacts. Thus, for example, the sloped wall portions of a trapezoidal cross-section light-turning structure may have a nominal slope of 85° with respect to the plane of a second optical film, but this slope may vary ±2° along the length of each such trapezoidal light-turning structure and/or from light-turning structure to light-turning structure. In another example, the height of each light-turning structure may vary ±5% from an average height along the light-turning structure's length. Various other types of dimensional variation may be applied to light-turning structures, as desired, and the above examples, while providing some context, should not be viewed as limiting.

While the above discussion has focused largely on the structural characteristics of optical stack arrangements, the following discussion provides insight as to the functional benefits arrived at by use of such optical stacks.

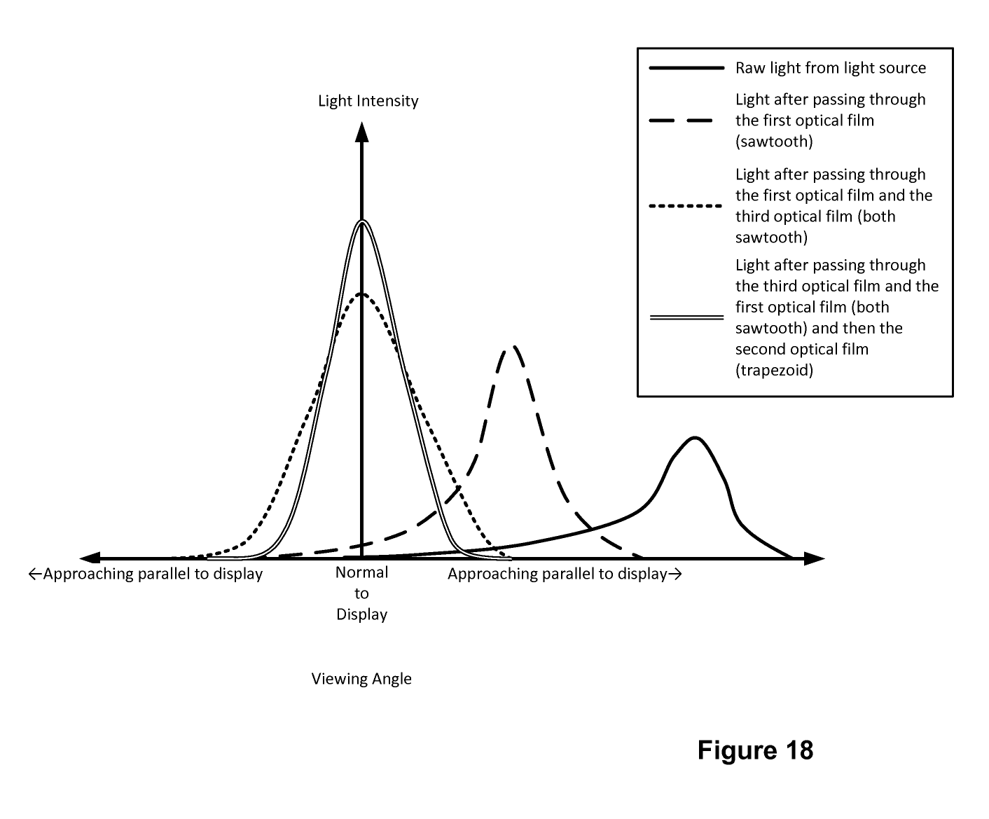

FIG. 18 depicts a diagram showing hypothetical brightness data for various optical stack configurations. The vertical axis indicates brightness level and the horizontal axis indicates viewing angle, for example, the angle that a person's sightline to the optical stack makes with respect to a vector that is normal to the optical stack. As shown, a bare light source in this example may emit raw light that is heavily weighted in intensity towards off-axis viewing angles. After passing through a first optical film, the peak intensity of the emitted light may have increased with respect to the peak intensity of the raw light and also may have shifted such that the peak intensity occurs at angles that are closer to on-axis than with the raw light. By adding a third optical film—in this case, arranged orthogonally to the first optical film, the peak intensity may be further increased and moved closer to on-axis. In the example, the use of the first optical film and the third optical film together has resulted in the peak intensity occurring for viewing angles that are substantially normal to the optical stack.

Thus, the first and/or third optical films may provide a mechanism by which light from a light source, such as light that may be emitted across the surface of a light guide coupled with one or more lamps, that is substantially aligned with an axis that is normal to the first and/or third optical films, such as light that is within 0 to 5 degrees or 0 to 10 degrees of the normal axis, for example, may be reflected back towards the light source while causing light that is not substantially aligned with such a normal axis to pass through the first and third optical films without reflection back towards the light source. It is to be understood that in such cases, there may be some light that is aligned with the normal axis that may not be reflected back towards the light source, but that the majority of light that is aligned with the normal axis will be reflected back towards the light source. For example, if the first and third optical films are both films similar to the first optical film 1424 shown in FIG. 14, light that is on-axis and that happens to strike the “tops” of the rounded peaks 1436 of the prismatic light-turning structures 1430 depicted in FIG. 14 will pass through the first optical film 1424 since the local angle of incidence of such light with respect to the second surface 1428 of the first optical film 1424 at such a peak 1436 of a prismatic light-turning structure 1430 is 90 degrees, which would not cause total internal reflection of the light. However, the majority of the light that is aligned with a normal axis that passes through the first optical film 1424 in FIG. 14 will strike the sloped portions of each light-turning structure since the sloped portions extend across a much larger portion of the first optical film 1424 than do the rounded peaks 1436, and thus be subject to reflection back towards the light source since the angle of incidence with respect to the second surface at such locations will be much less than 90 degrees, for example, 45 degrees. The majority of light that passes into the first optical film #1424 of FIG. 14 and that is not aligned with the normal axis may generally be passed through the first optical film 1424 (although it may be redirected to be more aligned with the normal axis upon exiting the first optical film 1424). In some such implementations, the first and/or third optical films may include optical cavities for redirecting the light and the optical cavities may be configured to cause the majority of light that is within the optical cavities and within less than 5 degrees of the normal axis to be reflected back towards the light source, while permitting the majority of light that is within 5 degrees to 90 degrees of the normal axis to pass through the first and/or third optical film without being reflected back towards the light source.

If a second optical film is added to the optical stack, as discussed in the examples provided earlier, this has the effect of further increasing the intensity of the emitted light—however, this is accomplished without further shifting of the viewing angle at which the peak light intensity occurs. It should be understood that adding another optical film such as the first optical film or the third optical film to the optical stack would actually have the opposite effect—peak intensity would be reduced as compared to the first optical film and the third optical film alone.

Thus, the second optical film (as well as any additional optical films in addition to the second optical film) may provide a mechanism by which light that is provided from the light source by way of the first and/or third optical films and that is generally aligned with the normal axis upon entry into the second optical film, such as may be the case if the angle between the light and the normal axis is equal to or less than, for example, the angles between the sloped wall portions of trapezoidal cross-section prismatic light turning structures of such a second optical film and the normal axis, may pass through the second optical film without being reflected back towards the light source. While some light that strikes the interstitial portions of the second optical film where there may be reflective material may be reflected back towards the light source, the majority of light is generally aligned with the normal axis and that passes into the base portions of the second optical film will be passed through the second optical film without being reflected back. At the same time, the second optical film may cause light that is not generally aligned with the normal axis of the second optical film to be redirected such that is more aligned with the normal axis as it passes through the second optical film. Generally speaking, this describes the majority of the light that enters the second optical film and that is not generally aligned with the normal axis. In some implementations, the second and, if used, additional optical films also may include optical cavities for redirecting the light, but these optical cavities may be configured to cause the majority of light that is within the optical cavities and within less than 22.55 degrees of the normal axis to pass through the second (or additional) optical film without being reflected back towards the light source, while permitting the majority of light that is within 22.5 degrees to 90 degrees of the normal axis to pass through the second optical film while being redirected such that it is more aligned with the normal axis upon exiting the second optical film.

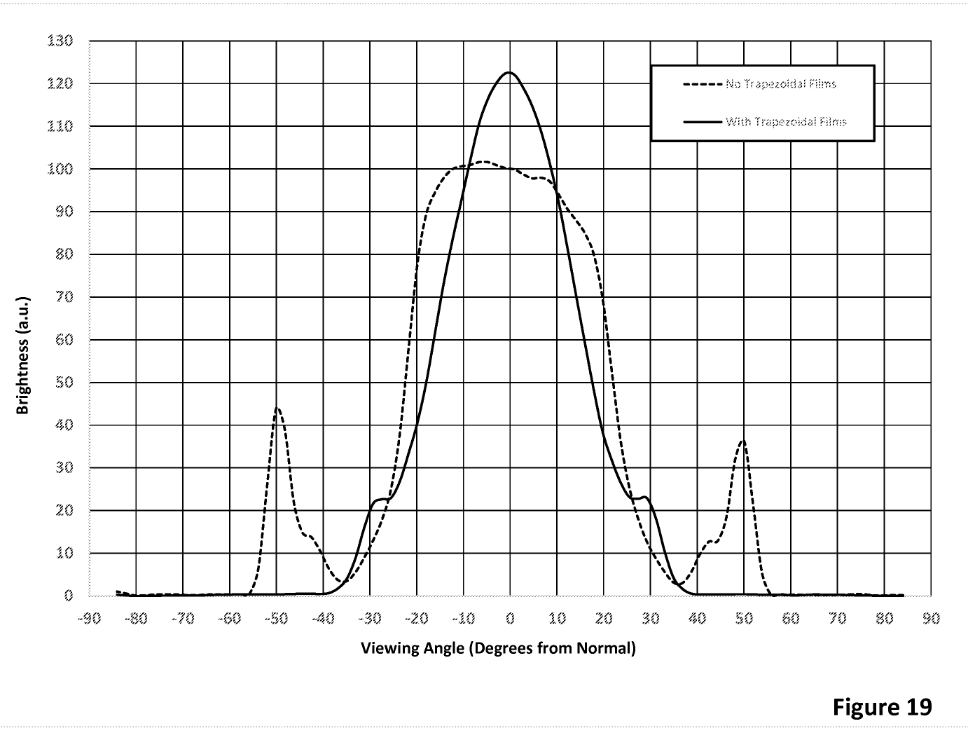

FIG. 19 is a plot of simulation data showing brightness as a function of viewing angle for optical stacks with and without an optical layer having trapezoidal light-turning structures. As can be seen in FIG. 19, two data traces are shown. The first data trace, which is shown as a dashed line and is labeled “No Trapezoidal Film,” represents intensity data (shown in arbitrary units or “a.u.”) as a function of viewing angle for an optical stack having a first optical film and a third optical film, i.e., two sawtooth-profile optical films. The second data trace, which is shown as a solid line and is labeled as “With Trapezoidal Film,” represents intensity data as a function of viewing angle for an optical stack having a first optical film and a third optical film, which are sawtooth-profile optical films, in addition to a second optical film and an additional optical film, which are both optical films having trapezoidal light-turning structures. As can be seen, the inclusion of the second optical film and additional optical film in the optical stack (in line with the arrangements discussed earlier) causes the on-axis intensity to increase by nearly 25% as compared with an optical stack that includes only the first optical film and the third optical film.

For reference, the sawtooth-profile optical films used in this simulation were identical (although arranged orthogonally to one another) and both had apex angles of 90°, a prism pitch of 50 μm, and an index of refraction of 1.5. The second and additional optical films used in the simulation were also identical to one another (but arranged orthogonally to one another) and had geometries similar to those depicted in FIG. 10. The first and second sloped wall portions in this case were sloped at 15° off-axis from an axis normal to the second and additional optical films, the base portions were 40 μm wide, the interstitial portions 80 μm wide, the height of the protrusions 115 μm, and the index of refraction was also 1.5.

It is to be understood that this disclosure is also directed at techniques of manufacturing the structures described herein, including, for example, techniques in which the various elements described herein are placed into relative positions with respect to one another to form an assembly or subassembly.

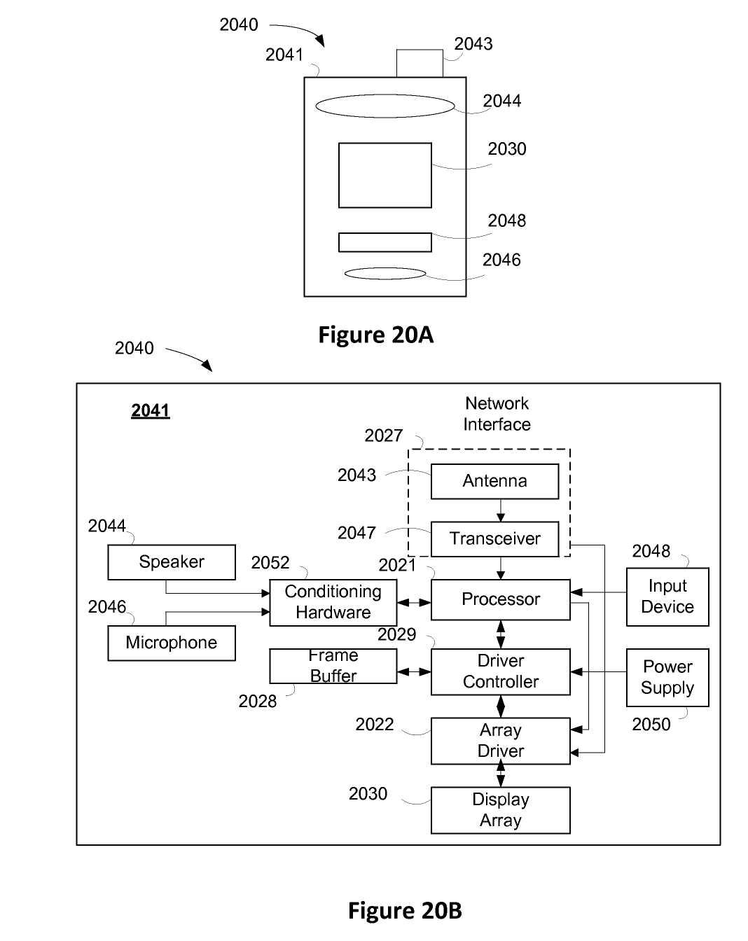

FIGS. 20A and 20B show system block diagrams of an example display device 2040 that includes a plurality of display elements. The display device 2040 can be, for example, a smart phone, a cellular or mobile telephone. However, the same components of the display device 2040 or slight variations thereof are also illustrative of various types of display devices such as televisions, computers, tablets, e-readers, hand-held devices and portable media devices.

The display device 2040 includes a housing 2041, a display 2030, an antenna 2043, a speaker 2045, an input device 2048 and a microphone 2046. The housing 2041 can be formed from any of a variety of manufacturing processes, including injection molding, and vacuum forming. In addition, the housing 2041 may be made from any of a variety of materials, including, but not limited to: plastic, metal, glass, rubber and ceramic, or a combination thereof. The housing 2041 can include removable portions (not shown) that may be interchanged with other removable portions of different color, or containing different logos, pictures, or symbols.

The display 2030 may be any of a variety of displays, including a bi-stable or analog displays, as described herein. The display 2030 also can be capable of including a flat-panel display, such as plasma, electroluminescent (EL) displays, OLED, super twisted nematic (STN) display, LCD, or thin-film transistor (TFT) LCD, or a non-flat-panel display, such as a cathode ray tube (CRT) or other tube device. In addition, the display 30 can include a mechanical light modulator-based display, as described herein. The display may be equipped with an optical stack and potentially other components, as described herein, in order to provide illumination to the display.

The components of the display device 2040 are schematically illustrated in FIG. 20B. The display device 2040 includes a housing 2041 and can include additional components at least partially enclosed therein. For example, the display device 2040 includes a network interface 2027 that includes an antenna 2043 which can be coupled to a transceiver 2047. The network interface 2027 may be a source for image data that could be displayed on the display device 2040. Accordingly, the network interface 2027 is one example of an image source module, but the processor 2021 and the input device 2048 also may serve as an image source module. The transceiver 2047 is connected to a processor 2021, which is connected to conditioning hardware 2052. The conditioning hardware 2052 may be configured to condition a signal (such as filter or otherwise manipulate a signal). The conditioning hardware 2052 can be connected to a speaker 2045 and a microphone 2046. The processor 2021 also can be connected to an input device 2048 and a driver controller 2029. The driver controller 2029 can be coupled to a frame buffer 2028, and to an array driver 2022, which in turn can be coupled to a display array 2030. One or more elements in the display device 2040, including elements not specifically depicted in FIG. 20A, can be capable of functioning as a memory device and be capable of communicating with the processor 2021. In some implementations, a power supply 2050 can provide power to substantially all components in the particular display device 2040 design.

The network interface 2027 includes the antenna 2043 and the transceiver 2047 so that the display device 2040 can communicate with one or more devices over a network. The network interface 2027 also may have some processing capabilities to relieve, for example, data processing requirements of the processor 2021. The antenna 2043 can transmit and receive signals. In some implementations, the antenna 2043 transmits and receives RF signals according to any of the IEEE 16.11 standards, or any of the IEEE 802.11 standards. In some other implementations, the antenna 2043 transmits and receives RF signals according to the Bluetooth® standard. In the case of a cellular telephone, the antenna 2043 can be designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G, 4G or 5G, or further implementations thereof, technology. The transceiver 2047 can pre-process the signals received from the antenna 2043 so that they may be received by and further manipulated by the processor 2021. The transceiver 2047 also can process signals received from the processor 2021 so that they may be transmitted from the display device 2040 via the antenna 2043.

In some implementations, the transceiver 2047 can be replaced by a receiver and/or a transmitter. In addition, in some implementations, the network interface 2027 can be replaced by an image source, which can store or generate image data to be sent to the processor 2021. The processor 2021 can control the overall operation of the display device 2040. The processor 2021 receives data, such as compressed image data from the network interface 2027 or an image source, and processes the data into raw image data or into a format that can be readily processed into raw image data. The processor 2021 can send the processed data to the driver controller 2029 or to the frame buffer 2028 for storage. Raw data typically refers to the information that identifies the image characteristics at each location within an image. For example, such image characteristics can include color, saturation and gray-scale level.

The processor 2021 can include a microcontroller, CPU, or logic unit to control operation of the display device 2040. The conditioning hardware 2052 may include amplifiers and filters for transmitting signals to the speaker 2045, and for receiving signals from the microphone 2046. The conditioning hardware 2052 may be discrete components within the display device 2040, or may be incorporated within the processor 2021 or other components.

The driver controller 2029 can take the raw image data generated by the processor 21 either directly from the processor 2021 or from the frame buffer 2028 and can re-format the raw image data appropriately for high speed transmission to the array driver 2022. In some implementations, the driver controller 2029 can re-format the raw image data into a data flow having a raster-like format, such that it has a time order suitable for scanning across the display array 2030. Then the driver controller 2029 sends the formatted information to the array driver 2022. Although a driver controller 2029 is often associated with the system processor 2021 as a stand-alone Integrated Circuit (IC), such controllers may be implemented in many ways. For example, controllers may be embedded in the processor 2021 as hardware, embedded in the processor 2021 as software, or fully integrated in hardware with the array driver 2022.

The array driver 2022 can receive the formatted information from the driver controller 2029 and can re-format the video data into a parallel set of waveforms that are applied many times per second to the hundreds, and sometimes thousands (or more), of leads coming from the display's x-y matrix of display elements. In some implementations, the array driver 2022 and the display array 2030 are a part of a display module. In some implementations, the driver controller 2029, the array driver 2022, and the display array 2030 are a part of the display module.

In some implementations, the driver controller 2029, the array driver 2022, and the display array 2030 are appropriate for any of the types of displays described herein. For example, the driver controller 2029 can be a conventional display controller or a bi-stable display controller (such as a mechanical light modulator display element controller). Additionally, the array driver 2022 can be a conventional driver or a bi-stable display driver (such as a mechanical light modulator display element controller). Moreover, the display array 2030 can be a conventional display array or a bi-stable display array (such as a display including an array of mechanical light modulator display elements). In some implementations, the driver controller 2029 can be integrated with the array driver 2022. Such an implementation can be useful in highly integrated systems, for example, mobile phones, portable-electronic devices, watches or small-area displays.

In some implementations, the input device 2048 can be configured to allow, for example, a user to control the operation of the display device 2040. The input device 2048 can include a keypad, such as a QWERTY keyboard or a telephone keypad, a button, a switch, a rocker, a touch-sensitive screen, a touch-sensitive screen integrated with the display array 2030, or a pressure- or heat-sensitive membrane. The microphone 2046 can be configured as an input device for the display device 2040. In some implementations, voice commands through the microphone 2046 can be used for controlling operations of the display device 2040. Additionally, in some implementations, voice commands can be used for controlling display parameters and settings.

The power supply 2050 can include a variety of energy storage devices. For example, the power supply 2050 can be a rechargeable battery, such as a nickel-cadmium battery or a lithium-ion battery. In implementations using a rechargeable battery, the rechargeable battery may be chargeable using power coming from, for example, a wall socket or a photovoltaic device or array. Alternatively, the rechargeable battery can be wirelessly chargeable. The power supply 2050 also can be a renewable energy source, a capacitor, or a solar cell, including a plastic solar cell or solar-cell paint. The power supply 50 also can be configured to receive power from a wall outlet.

In some implementations, control programmability resides in the driver controller 2029 which can be located in several places in the electronic display system. In some other implementations, control programmability resides in the array driver 2022. The above-described optimization may be implemented in any number of hardware and/or software components and in various configurations.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower,” or “vertical” and “horizontal,” are sometimes used for ease of describing the figures, and indicate relative positions corresponding to the orientation of the figure on a properly oriented page, and may not reflect the proper orientation of any device as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus comprising:
a first optical film having a first surface and a second surface located opposite the first surface of the first optical film; and
a second optical film having a first surface facing the first optical film and a second surface located opposite the first surface of the second optical film, wherein:
the second surface of the first optical film is defined by a plurality of prismatic light-turning structures,
each prismatic light-turning structure that is included in the plurality of prismatic light-turning structures that defines the second surface of the first optical film has a substantially triangular cross-section,
the second optical film includes a plurality of prismatic light-turning structures,
each prismatic light-turning structure of the plurality of prismatic light-turning structures included in the second optical film has a trapezoidal cross-section,
each trapezoidal cross-section widens with increasing distance from the first optical film, and
the first optical film and the second optical film are positioned in a stacked arrangement with the second surface of the first optical film facing towards the first surface of the second optical film.

2. The apparatus of claim 1, further comprising a light source, wherein the first optical film is interposed between the light source and the second optical film.

3. The apparatus of claim 1, further comprising:
a display pixel layer having a plurality of display elements, wherein the second optical film is interposed between the first optical film and the display pixel layer.

4. The apparatus of claim 3, wherein the display pixel layer includes
an aperture plate having a plurality of apertures, wherein:
each display element includes a shutter,
each shutter is associated with one or more of the apertures, and
each shutter is configured to be transitioned between a first position in which the shutter occludes the one or more of the associated apertures and a second position in which the shutter permits light to pass through the one or more associated apertures.

5. The apparatus of claim 3, wherein the display pixel layer is a liquid crystal display layer.

6. The apparatus of claim 1, wherein the prismatic light-turning structures in the plurality of prismatic light-turning structures that defines the second surface of the first optical film have a continuous sawtooth profile when viewed along a direction parallel to the prismatic light-turning structures of the first optical film.

7. The apparatus of claim 6, wherein the sawtooth profile is defined by alternating peaks and valleys, each of which forms an angle between 88° and 92° degrees.

8. The apparatus of claim 6, wherein the first surface of the first optical film is flat.

9. The apparatus of claim 1, further comprising a third optical film having a first surface and a second surface located on a side of the third optical film opposite the first surface of the third optical film, wherein:
the second surface of the third optical film is defined by a plurality of prismatic light-turning structures,
each prismatic light-turning structure that is included in the plurality of prismatic light-turning structures that defines the second surface of the third optical film has a substantially triangular cross-section,
the third optical film is positioned in the stacked arrangement with the second surface of the third optical film facing towards the first surface of the first optical film, and
the third optical film is oriented such that the prismatic light-turning structures in the plurality of prismatic light-turning structures that defines the second surface of the third optical film are oriented along a first direction substantially perpendicular to a second direction along which the prismatic light-turning structures in the plurality of prismatic light-turning structures that defines the second surface of the first optical film are oriented.

10. The apparatus of claim 9, wherein:
the prismatic light-turning structures in the plurality of prismatic light-turning structures that defines the second surface of the first optical film have a continuous sawtooth profile when viewed along a direction parallel to the prismatic light-turning structures of the first optical film, and
the prismatic light-turning structures in the plurality of prismatic light-turning structures that defines the second surface of the third optical film have a continuous sawtooth profile when viewed along a direction parallel to the prismatic light-turning structures of the second optical film.

11. The apparatus of claim 1, further comprising one or more additional optical films, wherein:
the second optical film is interposed between the first optical film and the one or more additional optical films,
each additional optical film includes a plurality of prismatic light-turning structures, and
each prismatic light-turning structure of the plurality of prismatic light-turning structures included in each of the one or more additional optical films has a trapezoidal cross-section.

12. The apparatus of claim 1, wherein:
each prismatic light-turning structure of the plurality of prismatic light-turning structures included in the second optical film includes a first sloped wall portion, a second sloped wall portion, and a base portion that is substantially in-plane with the second optical film and spans between the first sloped wall portion and the second sloped wall portion.

13. The apparatus of claim 12, wherein the second optical film includes interstitial portions that are located between each pair of adjacent base portions and are substantially in-plane with the first surface of the second optical film, wherein each interstitial portion includes reflective material facing towards the first optical film.

14. The apparatus of claim 12, wherein:
the first sloped wall portion and the second sloped wall portion of each prismatic light-turning structure of the plurality of prismatic light-turning structures included in the second optical film form an angle between them selected from the group consisting of: an angle greater than or equal to 5° and less than or equal to 45°, an angle eater than or equal to 5° and less than or equal to 15°, and an angle of approximately 10°.

15. The apparatus of claim 12, wherein:
the second optical film includes interstitial portions that are located between each pair of adjacent base portions, and
the interstitial portions and the base portions are substantially equal in width.

16. The apparatus of claim 12, wherein, for each pair of adjacent prismatic light-turning structures in the plurality of trapezoidal light-turning structures included in the second optical film, the first sloped wall portion of one of the prismatic light-turning structures in the pair of adjacent prismatic light-turning structures in the plurality of prismatic light-turning structures included in the second optical film and the second sloped wall portion of the other of the prismatic light-turning structures in the pair of adjacent light-turning structures in the plurality of prismatic light-turning structures included in the second optical film are provided by opposing walls of a V-shaped groove in the first surface of the second optical film.

17. The apparatus of claim 16, wherein the V-shaped grooves are coated or filled with a material selected from the group consisting of: a reflective material and a material having a lower index of refraction as compared with the material adjoining the V-shaped grooves.

18. The apparatus of claim 12, wherein, for each pair of adjacent prismatic light-turning structures in the plurality of prismatic light-turning structures included in the second optical film, the first sloped wall portion of one of the prismatic light-turning structures in the pair of adjacent prismatic light-turning structures in the plurality of prismatic light-turning structures included in the second optical film and the second sloped wall portion of the other of the prismatic light-turning structures in the pair of adjacent prismatic light-turning structures in the plurality of prismatic light-turning structures included in the second optical film are provided by opposing sides of a protrusion that defines a portion of the second surface of the second optical film.

19. The apparatus of claim 18, wherein the first sloped wall portions and the second sloped wall portions are both coated with a reflective coating.

20. The apparatus of claim 3, further comprising:
a processor capable of communicating with the display elements in the display pixel layer, the processor being capable of processing image data; and
a memory device capable of communicating with the processor.

21. The apparatus of claim 20, further comprising:
a driver circuit capable of sending at least one signal to the display elements; and
a controller capable of sending at least a portion of the image data to the driver circuit.

22. The apparatus of claim 20, further comprising:
an image source module capable of sending the image data to the processor, wherein the image source module includes at least one item selected from the group consisting of: a receiver, a transceiver, and a transmitter.

23. The apparatus of claim 20, further comprising:
an input device capable of receiving input data and communicating the input data to the processor.

24. An apparatus comprising:
a light-emission means for emitting distributed illumination across an illumination surface of the light-emission means;
a first optical film, the first optical film including first means for reflecting the light from the light-emission means that is substantially aligned with an axis that is normal to the illumination surface of the light-emission means back towards the light-emission means while permitting the light that is not substantially aligned with the axis to pass through the first optical film; and
a second optical film, the second optical film including second means for generally permitting the light from the light-emission means that passes through the first optical film and that is substantially aligned with the axis to pass through the second optical film without reflection back towards the light-emission means while causing the light from the light-emission means that passes through the first optical film and that is not substantially aligned with the axis to be reflected so as to be more aligned with the axis.

25. The apparatus of claim 24, wherein the first means causes the light that is within less than 5 degrees of the axis within optical cavities of the first means to be reflected back towards the light-emission means and causes the light that is within 5 degrees to 90 degrees of the axis within the optical cavities of the first means to pass through the first optical film.

26. The apparatus of claim 24, wherein the second means causes the light that is within less than 22.5 degrees of the axis within optical cavities of the second means to pass through the second means without being reflected back towards the light-emission means and causes the light that is within 22.5 to 90 degrees of the axis within the optical cavities of the second means to be reflected so as to be more aligned with the axis.

27. A system comprising:
a backlight unit (BLU) having a light source;
an optical stack including at least one first optical film and one second optical film, wherein:
the first optical film is interposed between the second optical film and the BLU,
the first optical film has a plurality of prismatic light-turning structures having a substantially triangular cross-section, and
the second optical film has a plurality of prismatic light-turning structures having a trapezoidal cross-section; and
a display pixel layer having a plurality of microelectromechanical systems (MEMS)-based display elements, each MEMS-based display element movable between at least two positions.

28. The system of claim 27, wherein the MEMS-based display elements are digital microshutter elements that are configured to be moved along axes that are parallel to the first optical film and the second optical film.

29. The system of claim 27, wherein the first optical film has a sawtooth profile and the prismatic light-turning structures of the first optical film have apex angles of 90°.

30. The system of claim 27, wherein each prismatic light-turning structure of the second optical film has sloped wall portions that have an included angle between them of between 5° and 45°.
